(19) United States
(12) Patent Application Publication
(10) Pub. No.: US 2018/0304179 A1
(43) Pub. Date: Oct. 25, 2018

(54) FILTER ASSEMBLY AND RELIEF VALVE OF SAME

(71) Applicant: Fram Group IP LLC, Lake Forest, IL (US)

(72) Inventors: Daniel Auxter, Genoa, OH (US); Timothy L. Memmer, Bowling Green, OH (US)

(21) Appl. No.: 15/957,005

(22) Filed: Apr. 19, 2018

Related U.S. Application Data
(60) Provisional application No. 62/489,035, filed on Apr. 24, 2017.

(51) Int. Cl. B01D 35/147; B01D 39/18; B01D 29/33; B01D 35/153

(52) U.S. Cl. CPC B01D 35/1475; B01D 39/18; B01D 29/333; B01D 35/153; B01D 2201/34; B01D 2201/0461; B01D 2201/12; B01D 2201/167; B01D 2201/291; B01D 2201/0438

(57) ABSTRACT

A filter assembly comprises a housing open at one end, a filter element therein, and a plate at the open end enclosing the filter element within the housing. The filter assembly further includes a fluid flow control assembly disposed between an end of the filter element and the plate. The fluid flow control assembly includes a check valve and a relief valve seat upon which the check valve abuts to prevent flow of fluid through a by-pass passage. The check valve is held in a sealed position against the relief valve seat by a biasing member retained by the relief valve seat. The force of the biasing member is overcome when pressure in the fluid acting upon the check valve reaches or exceeds a certain level, causing the check valve to move away from the relief valve seat, and permitting the fluid to flow through the relief valve assembly to an outlet opening of the filter assembly, bypassing the filter element of the filter assembly.

### CROSS REFERENCE TO RELATED APPLICATIONS

This application claims the benefit of priority to U.S. Provisional Patent Application No. 62/489,035 filed on Apr. 24, 2017. The disclosures set forth in the referenced application are incorporated herein by reference in their entirety.

### BACKGROUND

### 1. Field of the Disclosure

The present invention relates generally to a fluid filter assembly and, more particularly, to a fluid filter assembly having a relief valve.

### 2. Background of the Disclosure

Filter assemblies generally include a housing having an open end, a filter element received in the housing, an base plate closing the open end and having inlet and outlet openings therein, and a valve for cooperating with the inlet openings to allow oil to flow into the filter through the inlet openings, but prevent flow of oil in a reverse direction. Prior art filters have included a combination valve having two portions, the first portion for closing the inlet openings to block the flow of oil back out of the inlet openings when the oil is not being circulated and the second portion for opening a bypass opening when the filter media is clogged for returning oil to the engine to keep the engine lubricated even though the filter element is clogged. Such a construction is disclosed in Stanhope et al. U.S. Pat. No. 7,175,761.

The present disclosure improves upon current valves and overcomes disadvantages and deficiencies of such prior art constructions.

### SUMMARY

In an illustrative embodiment, a filter assembly comprises a housing open at one end and holding a filter element therein and a plate closing the open end of the housing and enclosing the filter element within the housing. The filter assembly further includes a fluid flow control assembly disposed between an end of the filter element and the plate. The fluid flow control assembly includes a check valve and a relief valve assembly, the relief valve assembly including a relief valve seat upon which the check valve seals to prevent flow of fluid through a by-pass passage of the fluid flow control assembly. The check valve is held in a sealed position against the relief valve seat by a biasing member retained in place by the relief valve seat. The force of the biasing member is overcome when pressure in the fluid acting upon the check valve reaches or exceeds a certain level, causing the check valve to move away from the relief valve seat against the bias of the biasing member, and permitting the fluid to flow through the relief valve assembly to an outlet opening of the filter assembly, bypassing the filter element of the filter assembly.

In any of the embodiments herein, the relief valve assembly may comprise a valve seat with a seat portion and a centering portion. The seat portion may extend generally perpendicular to a longitudinal axis of the filter assembly when the relief valve assembly is inserted into the filter assembly. The valve seat may be configured to extend through an aperture of the check valve with an end point of the check valve abutting an outer surface of the valve seat. The check valve may include a horizontal portion that terminates at the end point, the horizontal portion extending across a portion of the valve seat to block flow of fluid through an aperture in the relief valve assembly.

In any illustrative embodiment, the valve seat may include a check valve sealing ring within the seat portion. The check valve sealing ring includes an upper surface upon which the check valve rests when sealed against the seat portion to seal the aperture of the relief valve assembly. The check valve may be maintained in the sealed position against the check valve sealing ring by a bias force applied to the top of the check valve above the check valve sealing ring, where the bias force can only be overcome by application of a predetermined force from fluid flowing in a by-pass passageway of the valve seat upon the check valve.

In any illustrative embodiment, the relief valve assembly may comprise a biasing member that biases the check valve into sealing arrangement with the check valve sealing ring, wherein the biasing member is held in place by one or more stop surfaces of the valve seat. The biasing member may be a spring or other similar mechanism that is held between the stop surfaces and a top surface of the check valve to maintain the check valve in a closed position. An optional washer may extend between a bottom surface of the biasing member and the top surface of the check valve, such that the optional washer is capable of transferring pressure from the biasing member to the check valve.

In any illustrative embodiment, the valve seat may further include a cartridge sealing ring that is annularly outward of the check valve sealing ring and that includes a top surface configured to permit a portion of the check valve to abut against. A bypass gap may extend between the cartridge sealing ring and the check valve sealing ring for fluid to flow through when the bypass path is not blocked by the check valve. The check valve is normally configured to extend over the bypass gap to prevent fluid flow therethrough, but the check valve is lifted away from the bypass gap when pressure in the fluid meets or exceeds a predetermined level.

In illustrative embodiments, the valve seat includes a centering portion that is substantially perpendicular to the seat portion and is configured to extend generally along the longitudinal axis of the filter assembly. The centering portion includes one or more annular walls that are configured to be partially received within a central core opening of the filter assembly to permit the valve seat to be properly centered therewith. The centering portion further includes one or more by-pass apertures that extend between the annular walls, the by-pass apertures fluidly connected to the flow of fluid passing through the by-pass gap in the seat portion of the valve seat. The by-pass apertures are configured to direct fluid flow to the outlet opening of the filter assembly when fluid flows through the by-pass gap, permitting such fluid to by-pass the filter element of the filter assembly.

In illustrative embodiments, the valve seat may further include a tapping plate or base plate sealing ring that substantially defines a bottom of the valve seat. The base plate sealing ring is configured to abut against a portion of a base plate of the filter assembly when the base plate is inserted into the filter housing. In certain embodiments, the base plate sealing ring is compressed against a shoulder portion of the base plate that extends into the housing, the shoulder portion including one or more of the inlet openings for fluid to flow into the filter assembly. The base plate sealing ring may include one or more alignment features that can align with one or more portions of the base plate to permit proper alignment of the fluid flow control assembly between the base plate. The fluid flow control assembly may be retained against the base plate without a snap or lock fit engagement.

In any illustrative embodiment, the valve seat may be configured as a two (or more) piece valve seat component that is assembled together as the relief valve assembly is assembled. In any illustrative embodiment, for instance, the check valve sealing ring that is formed as a separate component from the cartridge sealing ring. In other instances, the seat portion may be formed as a separate component from the centering portion of the valve seat. Other forms of separating the components of the valve seat are envisioned herein.

These and other features of the present disclosure are more full described with reference to the detailed description and drawings herein.

### BRIEF DESCRIPTION OF THE DRAWINGS

FIG. 1 is a side perspective view of a relief valve component for a filter assembly of an exemplary embodiment of the present disclosure;

FIG. 2 is an bottom perspective view of the relief valve component of FIG. 1;

FIG. 3 is a cross-sectional view of a filter assembly that includes a fluid flow control assembly, the fluid flow control assembly including a relief valve assembly that includes the relief valve component of FIG. 1 and a check valve, the fluid flow control assembly configured to rest on top of a threaded base plate or tapping plate at an end of the filter assembly that permits fluid to flow through the filter assembly;

FIGS. 4A and 4B are cross-sectional views of a section of the filter assembly of FIG. 3, illustrating a detailed view of the fluid flow control assembly in a natural state without fluid flowing through the filter assembly;

FIGS. 5A and 5B are cross-sectional views similar to FIGS. 4A and 4B, illustrating a detailed view of the fluid flow control assembly in a normal flow state, where fluid is flowing through the filter assembly and flow of fluid through the filter assembly is not substantially restricted;

FIGS. 6A and 6B are cross-sectional views similar to FIGS. 5A and 5B, illustrating a detailed view of the fluid flow control assembly in an alternative or by-pass flow state, where fluid flowing through the filter assembly is restricted or blocked to at least a certain extent such that the relief valve assembly permits fluid entering the filter assembly to by-pass a filter component of the filter assembly and thereby reduce pressure within the filter assembly;

FIG. 7 is a cross-sectional view of the relief valve component taken generally along the lines 7-7 of FIG. 1;

FIG. 8 is an exploded view of the filter assembly illustrated in FIG. 3, illustrating a filter housing, a filter component, a fluid flow control assembly, a threaded base plate, and an end or bottom plate, and wherein the fluid flow control assembly includes a relief valve assembly, including the relief valve component of FIG. 1, and a check valve;

FIG. 9 is an exemplary flow curve of flow rate to differential pressure in an exemplary embodiment of a fluid flow control assembly of the present disclosure;

FIG. 10 is a side perspective view of an alternative two-piece relief valve component for a filter assembly of an exemplary embodiment of the present disclosure;

FIG. 11 is an bottom perspective view of the two-piece relief valve component of FIG. 10;

FIG. 12 is an exploded view of the two-piece relief valve component of FIG. 10;

FIG. 13 is a side perspective view of another alternative two-piece relief valve component for a filter assembly of an exemplary embodiment of the present disclosure;

FIG. 14 is an bottom perspective view of the two-piece relief valve component of FIG. 13;

FIG. 15 is an exploded view of the two-piece relief valve component of FIG. 13;

FIG. 16 is a side perspective view of another alternative two-piece relief valve component for a filter assembly of an exemplary embodiment of the present disclosure;

FIG. 17 is an bottom perspective view of the two-piece relief valve component of FIG. 13; and

FIG. 18 is an exploded view of the two-piece relief valve component of FIG. 13.

### DETAILED DESCRIPTION

The present disclosure is directed to a filter assembly including a fluid flow control assembly. While the present disclosure may be embodied in many different forms, one specific embodiment is discussed herein with the understanding that the present disclosure is to be considered only as an exemplification of the principles of the disclosure, and it is not intended to limit the disclosure to the embodiment illustrated.

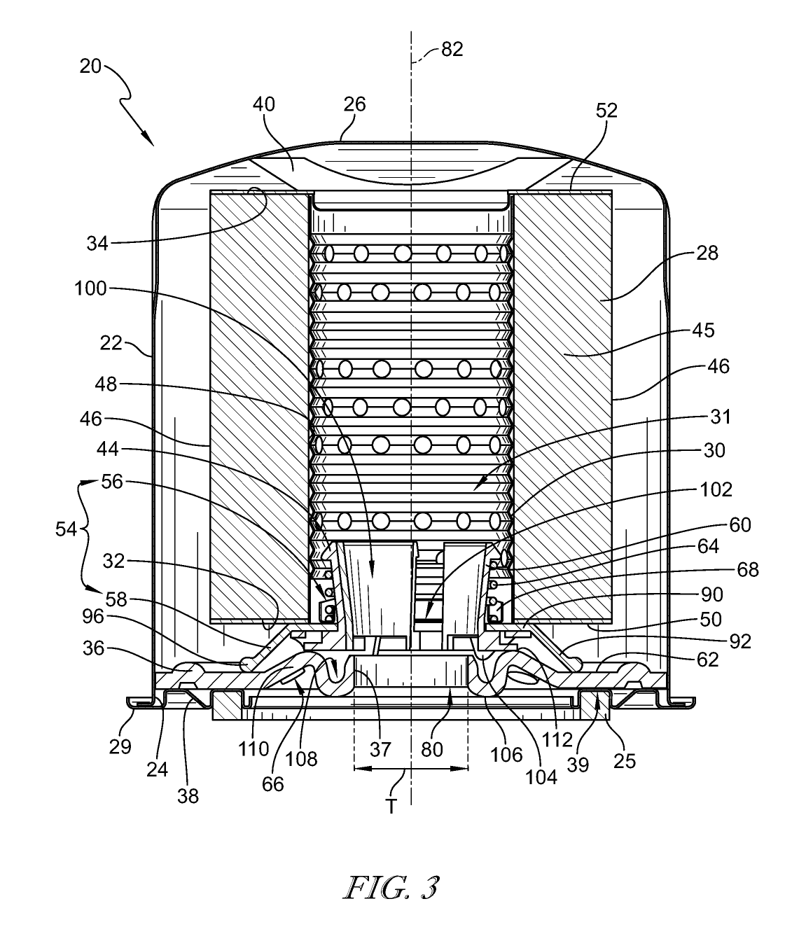

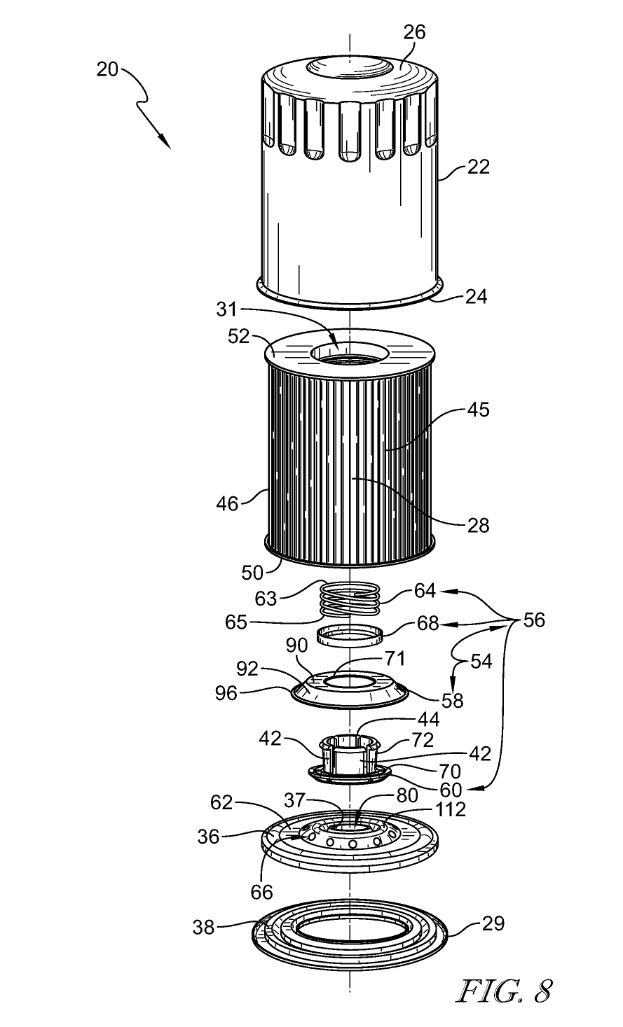

Referring to FIGS. 3 and 8, a filter assembly 20 is depicted as having a generally cup-shaped cylindrical shell or housing 22 that is open at a first or lower open end 24 and closed at a second or upper, opposite end 26. A filter, for example, in the form of a filter component or element 28 that includes filter media mounted on a core 30, is disposed within the housing 22, wherein the filter element 28 includes a first or lower end 32 positioned adjacent the first end 24 of the housing and a second or upper end 34 adjacent the second end 26 of the housing 22. The core 30 may define an opening 31 that fluid flows into after it has passed through the filter element 28, and the opening 31 may extend about a longitudinal axis 82 of the filter assembly 20 so that the opening 31 is substantially positioned within the center of the housing 22. In various embodiments, a lid 38 may be coupled to the lower open end 24 of the housing 22 to substantially enclose the filter assembly 20. While a particular filter is disclosed herein, one skilled in the art will understand that the principles of the present disclosure may be applied to any suitable filter assembly having any suitable filter.

In various embodiments of the filter assembly 20, a threaded base plate or tapping plate 36 is provided to be connected at the lower open end 24 of the housing 22. The base plate 36 may be configured between the lid 38 and the filter element 28 within the housing 22. An annular, resilient gasket 25 may be received and retained in a recess 39 in the lid 38 for providing a seal between the filter assembly 20 and an engine block (not shown) to which the filter assembly 20 is secured in normal use. Optionally, any other suitable additional or alternative seal may be used. A biasing element 40, for example, a spring, may be provided between the upper end 34 of the filter element 28 and an interior 44 of the housing 22 for biasing the filter element 28 toward the first end 24 of the housing 22. In illustrative embodiments, the biasing element 40 biases the filter element 28 toward the base plate 36 to apply pressure on the base plate 36. The biasing element 40 may be replaced with any suitable element(s) that bias the filter toward the first end 24 of the housing 22 or may be omitted.

The filter element 28 may include any suitable filter media 45 comprised of, for example, pleated filter material composed of cellulose with some polyester, although other forms of filter media are envisioned herein. The core 30, which may be molded from any appropriate material, for example, a glass filled plastic, such as, Nylon, is perforated so as to permit fluid flow therethrough in use. The filter element 28 may include a first face 46 suitable to receive and permit the flow of fluid through the filter element, and a second face 48 suitable to permit flow of fluid from the filter media, with the second face 48 being secured to the core 30, as seen in FIG. 3. The filter media 45 may be formed from a sheet of pleated material joined along the facing ends by a suitable adhesive to form an annular sleeve on the core 30. End caps 50, 52 may be disposed at the bottom and top, respectively, of the filter element 28. The end caps 50, 52 may be fabricated from a suitable composite material, for example, a cellulose/polyester composite. In various embodiments, the end caps 50 and 52 are configure to prevent the flow of fluid into the filter media 45 and may further direct the flow of fluid within the housing 22. In an illustrative embodiment, the end caps 50, 52 are bonded to the filter media 45, for example, by ultrasonic welding, to form a seal between the ends of the filter media 45 and the end caps 50, 52 to prevent fluid flow between these elements in use. The end caps 50, 52 may alternatively be bonded to the filter media in any other suitable manner. In various embodiments, the end caps 50 and 52 may be a non-rigid material, such as cellulose fiber or polyester.

In various embodiments, the end or base plate 36 may include various designs or configurations. For instance, the base plate 36 may be a double-draw design (as illustrated in FIG. 3), or it may be an inverted type of base plate 36. Other types of base plates 36 include a flat design. The present disclosure is directed for use in a filter assembly 20 that incorporates substantially any type of base plate 36 design. In an exemplary embodiment, the base plate 36 is configured to include a raised portion or shoulder 110 that extends inward into the housing 22 and towards the filter element 28 when the base plate 36 is secured in the housing 22. The raised portion 110 includes a top surface 112 that can abut against components retained in the housing 22, as further described herein. In various embodiments, the raised portion 110 includes one or more flow apertures 66 to permit flow of fluid into the filter assembly 20.

The filter element 28 and housing 22 of the filter assembly 20 may be similar to the filter element 28 and housing 22 disclosed in U.S. Pat. No. 7,175,761, the disclosure of which is hereby incorporated by reference in its entirety. In other illustrative embodiments, the principles of the present disclosure may be applied to any suitable filter assembly having any suitable housing and/or any suitable filter element.

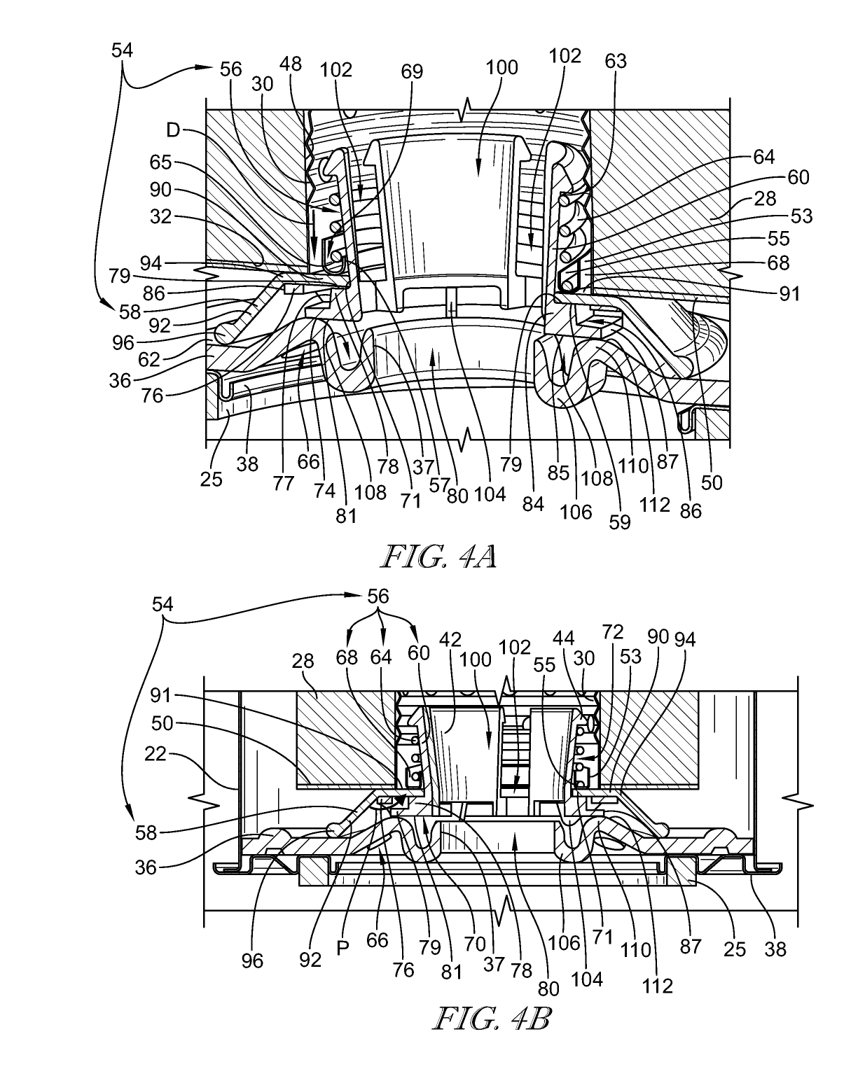

Referring to FIGS. 3-4B, an embodiment of a fluid flow control assembly 54 retained within the filter housing 22 is depicted. The fluid flow control assembly 54 includes a relief valve seat assembly 56 and a check valve 58, as will be described herein. The fluid flow control assembly 54 is retained adjacent the lower end 32 of the filter element 28 and a top or inner side 62 of the base plate 36. In various embodiments, the fluid flow control assembly 54 abuts against or contacts the raised portion 110 of the base plate 36, and may further rest or abut against the top surface 112 of the raised portion 110. In illustrative embodiments, the fluid flow control assembly 54 is configured to control flow of fluid that is entering the filter assembly 20 prior to the fluid being filtered through the filter element 28. An outlet opening 80 is provided centrally within the base plate 36, defined by a rim 37 of the base plate 37, to permit fluid to flow out of the filter assembly 20 and the fluid flow control assembly 54 may be configured to be adjacent to the outlet opening 80. As seen in FIG. 3, the outlet opening 80 may be centrally disposed about the longitudinal axis 82 of the filter assembly 20. While the outlet opening 80 is depicted as being circular in cross-section, the outlet opening 80 may have any other suitable configuration depending on the application for the filter assembly 20. Still optionally, the outlet opening 80 may be oriented in any suitable manner. The fluid flow control assembly 54 may be retained adjacent the outlet opening 80 such that the fluid flow control assembly 54 does not block or restrict flow of fluid as it exits through the outlet opening 80.

As illustrated in FIGS. 4A-6B, the check valve 58 of the fluid flow control assembly 54 is configured for controlling flow through a first inlet opening or openings 66 in the base plate 36. As illustrated, the openings 66 may extend through the raised portion 110 of the base plate 36, although other embodiments are envisioned herein. The check valve 58 is illustratively annular and includes a generally horizontal segment 90 that extends from an end point 71 and an angled segment 92 extending from the generally horizontal segment 90 and disposed at an angle with respect to the generally horizontal segment 90, thereby forming a bend 94. In an illustrative embodiment, the generally horizontal segment 90 extends from the end point 71 and the angled segment 92 extends at the angle with respect to a horizontal plane such that a free end 96 of the angled segment 92 is inclined outwardly and downwardly from the generally horizontal segment 90. The free end 96 is configured to abut against the top side 62 of the base plate 36 in its natural state. The free end 96 of the angled segment 92 may be bulbous or semi-bulbous to elevate the angled segment 92 and provide a gap between an elastomeric surface of the angled segment 92 and the base plate 36 to distribute pressure evenly across the check valve 58. Still further, the free end 96 may have any shape. In various embodiments, the check valve 58 is annularly disposed around the longitudinal axis 82 when positioned within the filter assembly 20. Still further in various embodiments, the inlet openings 66 of the base plate 36 may be positioned below the angled segment 92 of the check valve 58 when assembled in the filter assembly 20, and the inlet openings 66 may direct fluid flow against the angled segment 92 when directing fluid into the filter assembly 20. In certain embodiments, the raised portion 110 of the base plate 36 may be aligned under a portion of the check valve 58, such as the horizontal segment 90, and include the inlet openings 66 that direct flow of fluid toward the angled segment 92. The check valve includes a central aperture that may be substantially aligned with the outlet opening 80 of the base plate 36 and the longitudinal axis 82 of the filter assembly 20.

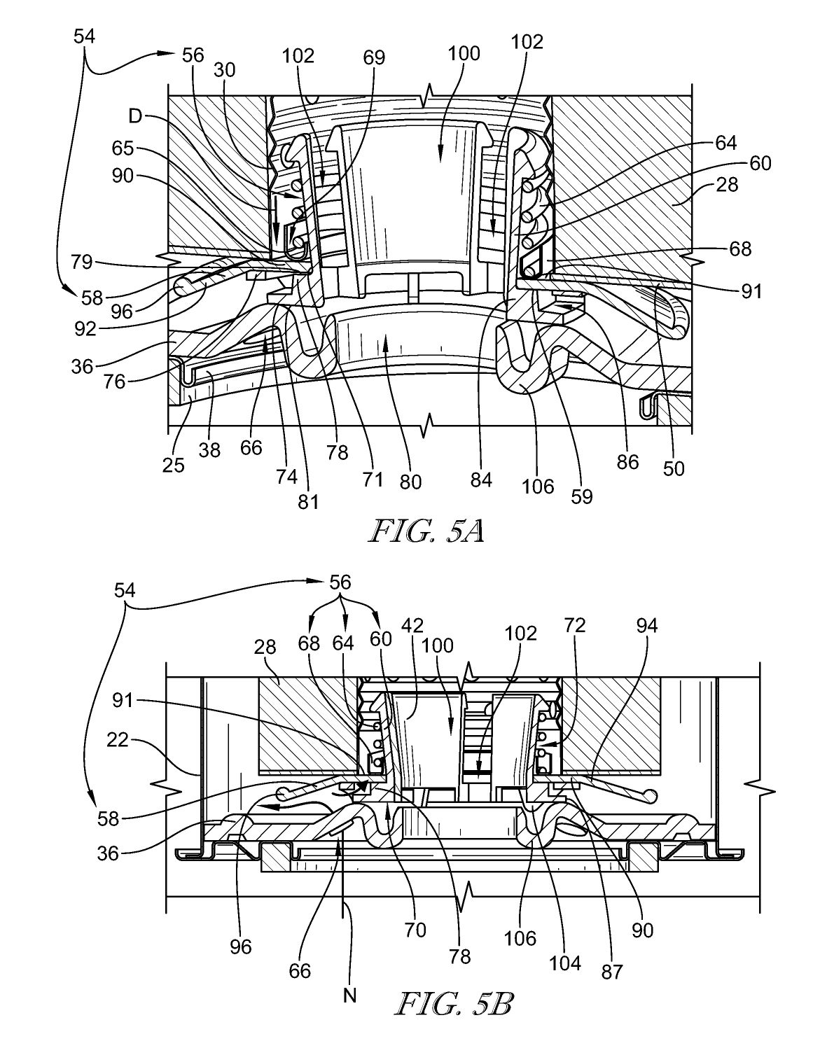

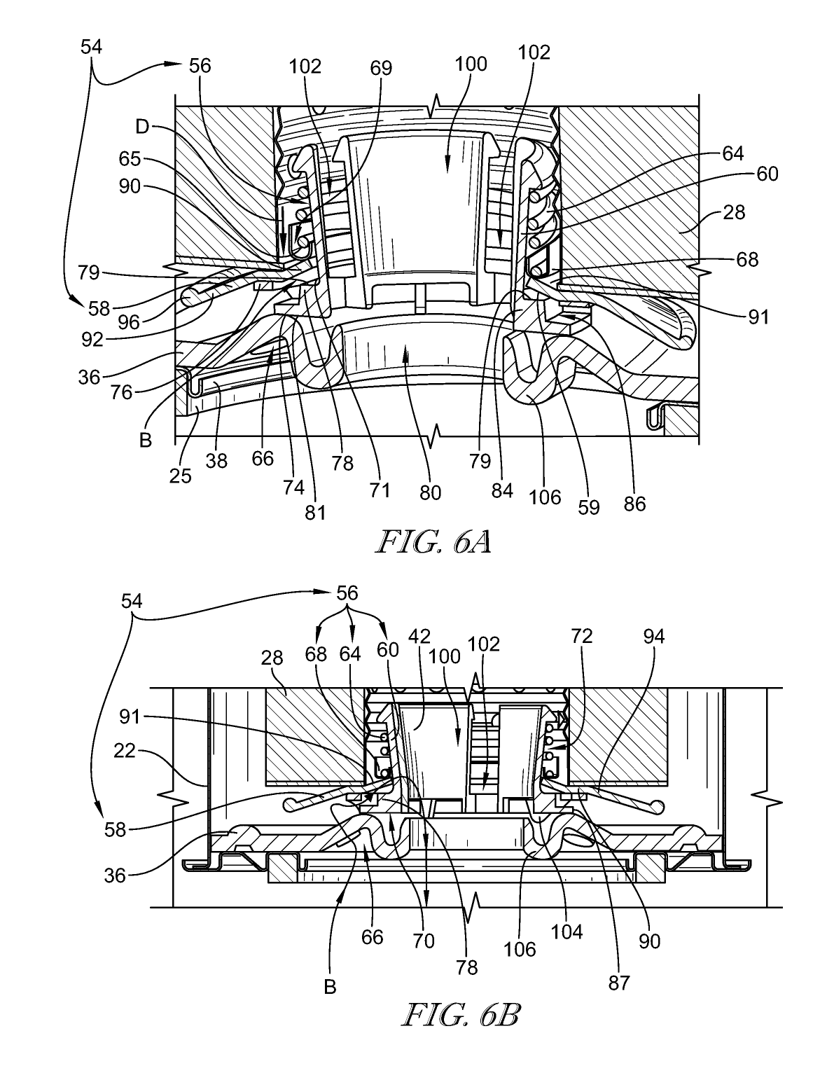

The check valve 58 may be made of rubber, plastic, an elastomeric material, or any other suitable material. The check valve 58 may be made of Nitrile, Silicone rubber, or any other suitable material. In various embodiments, the materials for the check valve 58 should be suitable for use with engine oil at up to 300 degrees Fahrenheit for several thousand miles. As is understood by review of FIGS. 4A-6B, the check valve 58, and at least some of its components such as the angled segment 92 and horizontal segment 90, are configured to be deformable or elastic such that a certain pressure of fluid abutting against the check valve 58 may deform or move such components relative to the rest of the components of the filter assembly 20. For instance, FIGS. 4A-4B illustrative show the check valve 58 in a natural state with no pressure applied thereto, FIGS. 5A-5B illustratively show the check valve 58 in a first state where pressure of a fluid is applied to the angled segment 92 (via fluid entering from the openings 66) to force the angled segment 92 upward such that a gap or space extends between the free end 96 and the base plate 36, and FIGS. 6A-6B illustrative show the check valve 58 in a second state where pressure of a fluid is applied to a portion of the horizontal segment 90 to force a portion of the horizontal segment 90 upward against a bias force such that fluid may pass between the horizontal segment 90 and the relief valve seat assembly 56, described below. In various embodiments, certain parts of the check valve 58 may be deformable independent of other parts of the check valve 58. In other embodiments, certain pressures of fluid may deform various parts of the check valve differently, or the parts of the check valve may uniformly deform at a certain pressure.

As illustrated in FIGS. 4A-6B, the relief valve seat assembly 56 of the fluid flow control assembly 54 is configured to work in conjunction with the check valve 58 to direct fluid flowing into the opening 66 of the base plate 36 to be directed to the outlet opening 80 without flowing through the filter element 28. For instance, the relief valve seat assembly 56 and check valve permit fluid to by-pass the filter element 28 within the filter assembly 20 when the pressure of the fluid flowing into the filter assembly 20 is at or above a certain level (e.g. when the pressure of the fluid is high because the filter element 28 is overly clogged, causing fluid flowing through the filter assembly 20 to be at a greater pressure).

In illustrative embodiments, the relief valve seat assembly 56 includes a valve seat 60, a biasing member 64, and a washer 68. As illustrated in FIGS. 4A-6B, the relief valve seat assembly 56 may also be annular to the longitudinal axis 82 of the filter assembly 20 when assembled within the filter assembly 20, similar to the check valve 58. Specifically, the valve seat 60 may have a longitudinal axis A that is generally configured to be aligned with the longitudinal axis 82 of the filter assembly 20 when the valve seat 60 is secured therein. The valve seat 60, biasing member 64, and washer 68 are configured to be retained in the lower end 24 of the housing 22, and may further be configured to abut against the raised portion 110 of the base plate 36 when secured within the housing 22. The relief valve seat assembly 56 may at least partially extend into the opening 31 formed by the core 30 of the filter element 28. As more fully described herein, the valve seat 60 provides a seat for a portion of the check valve 58 to abut against and further retains the biasing member 64 against the check valve 58 to bias the check valve 58 to be seated against a portion of the valve seat 60. The biasing member 64 is configured to move upward in the direction of the longitudinal axis 82 within the filter assembly 20 (e.g. within the valve seat 60). The relief valve seat assembly 56 cooperates together with the check valve 58 to permit fluid to by-pass the filter element 28 when exiting the outlet opening 80. Illustratively, a portion of the relief valve seat assembly 56 may extend through the center aperture of the check valve 58, with an exterior surface of the relief valve seat assembly 56 abutting against the end 71 of the horizontal segment 90 of the check valve 58.

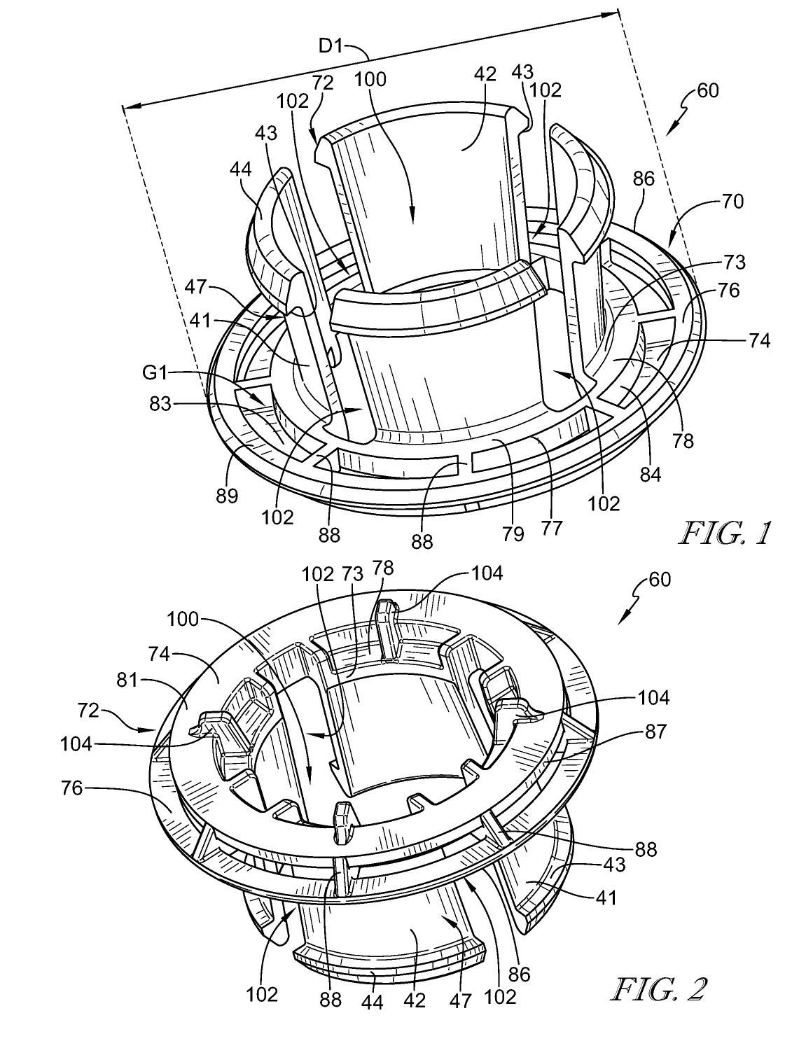

As illustrated for example in FIGS. 1-2 and 7, the valve seat 60 illustratively includes a seat portion 70 and a centering portion 72 coupled together at a connector portion 73. Both the seat portion 70 and centering portion 72 may be annular in nature to the longitudinal axis 82 when the valve seat 60 is incorporated into the filter assembly 20. The seat portion 70 may be generally horizontal in direction (that is, perpendicular to the longitudinal axis 82) and the centering portion 72 may be generally vertical in direction (that is, parallel to the longitudinal axis 82). In various embodiments, the seat portion 70 and centering portion 72 may be formed as a unitary component that is co-molded of the same material. In various embodiments, the seat and centering portions 70 and 72 may be made of rubber, plastic, an elastomeric material, or any other suitable material. For instance, the seat and centering portions 70 and 72 may be formed of nylon or a silicone-based or silicon-like material, although other materials are also envisioned herein. In illustrative embodiments, one or more components of the valve seat 60 may be formed of nylon, such as Nylon6, Nylon 6/6 or Nylon12. Any material that may be injection-molded or extruded and can withstand the environment of an oil filter may be used. In illustrative embodiments, the valve seat 60 may have a diameter DI that is approximately 1.700 inches, although other diameters are envisioned herein.

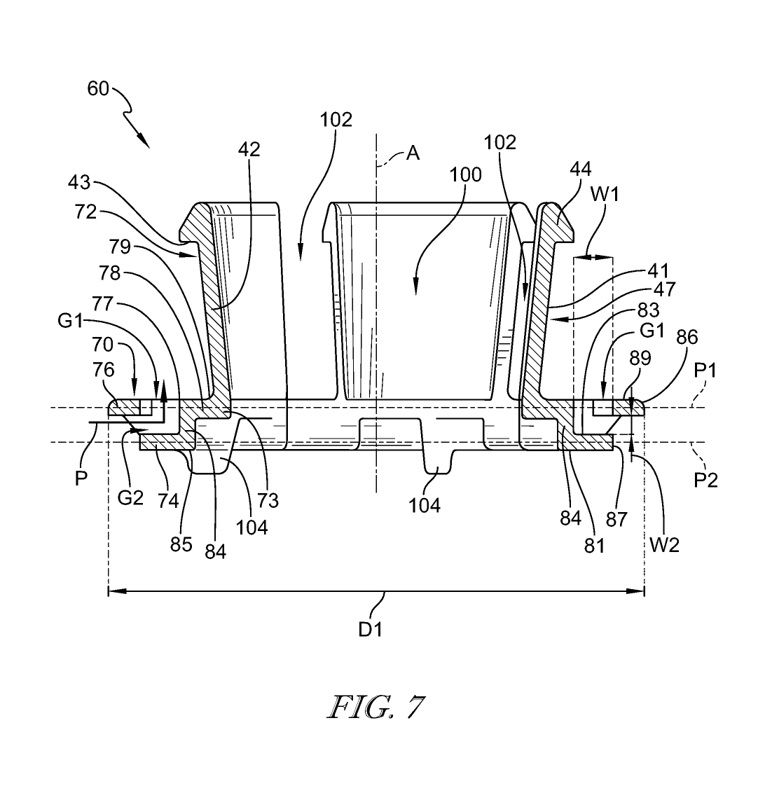

In various embodiments, the seat portion 70 of the valve seat 60 includes a base plate sealing ring 74, a cartridge sealing ring 76, and a check valve sealing ring 78, as illustrated in FIGS. 1-2. The check valve sealing ring 78 may be adjacent and connected to the connector portion 73 that connects the seat portion 70 to the centering portion 72 and extends annularly outward from the centering portion 72. Specifically, the check valve sealing ring 78 may extend along a plane P1 that is generally perpendicular to the longitudinal axis A of the relief valve seat assembly 56, as illustrated in FIG. 7. As illustrated in FIGS. 4A-5B, the check valve sealing ring 78 is configured to provide a sealing surface for the check valve 58 to seat against when the valve seat 60 is aligned within the central aperture of the check valve 58 along the longitudinal axis 82 of the filter assembly 20. Illustratively, a bottom surface 59 of the check valve 58 is configured to abut against a top surface 79 of the check valve sealing ring 78 to seal the check valve 58 to the valve seat 60 to prevent fluid flow therebetween. Such sealing may occur at or near the end point 71 of the check valve 58, although other locations are envisioned herein. In illustrative embodiments, the seat portion 70 may have a thickness (between top surface 79 and bottom surface 81) that may be between 0.160 inches and 0.210 inches, although other thicknesses are envisioned herein.

In illustrative embodiments, the base plate sealing ring 74 is configured to extend annularly outward of and below the check valve sealing ring 78 and be coupled thereto, as illustrated in FIG. 7. A connection wall 84 may extend downwardly from an outside edge 77 of the check valve sealing ring 78 to connect the base plate sealing ring 74 to the check valve sealing ring 78. For instance, the connection wall 84 may terminate at a bottom edge 85 of the connection wall 84, and the base plate sealing ring 74 may extend annularly outward of the bottom edge 85 in a direction that is horizontal to the connection wall 84 and longitudinal axis A of the relief valve seat assembly 56. The base plate sealing ring 74 may extend along a plane P2 that is substantially parallel to the check valve sealing ring 78 and plane P1, and the base plate sealing ring 74 may extend below the check valve sealing ring 78, as illustrated in FIG. 7 to create a horizontal gap between the sealing rings 74 and 78. Accordingly, the planes P1 and P2 may be spaced apart from each other. The base plate sealing ring 74 includes a bottom surface 81 and a top surface 83 and terminates at an end point 87 that is opposite to the bottom edge 85 of the connection wall 84.

In illustrative embodiments, the cartridge sealing ring 76 is configured to extend annularly outward of the check valve sealing ring 78, and may further extend annularly outward of the base plate sealing ring 74. In certain embodiments, the cartridge sealing ring 76 is generally aligned with the plane P1 of the check valve sealing ring 78 but is annularly spaced away from the check valve sealing ring 78 by a first gap G1 that can permit fluid to flow between the check valve sealing ring 78 and the cartridge sealing ring 76, as illustrated in FIG. 7. The first gap G1 may have a width measurement W1 of approximately 0.125 inches or 3.2 mm, although other measurements are envisioned herein. The cartridge sealing ring 76 may be coupled to the check valve sealing ring 78 by one or more connection bridges 88 that extend outwardly from the check valve sealing ring 78 to retain the cartridge sealing ring 76 to the rest of the valve seat 60. In various embodiments, the connection bridges 88 may be equally spaced apart around the circumference of the check valve sealing ring 78, although other embodiments are envisioned herein. The cartridge sealing ring 76 may be configured to align longitudinally with a portion of the end cap 50 of the filter element when the valve seat 60 is positioned within the housing 22 of the filter assembly 20. In various embodiments, the cartridge sealing ring 76 provides a supporting engagement between the valve seat 60 and the end cap 50 in order to secure the components with respect to each other within the filter assembly 20.

In various embodiments, a top surface 89 of the cartridge sealing ring 76 is aligned horizontally with the top surface 79 of the check valve sealing ring 78. Accordingly, the check valve sealing ring 78 and the cartridge sealing ring 76 are generally parallel to each other and provide two parallel surfaces 79 and 89 upon which the bottom surface 59 of the check valve 58 can abut against to seal the check valve 58 to the valve seat 60 to prevent fluid flow through the gap G1. The cartridge sealing ring 76 terminates at an end point 86. In illustrative embodiments, the end point 86 may be complimentarily shaped to be received in the bend 94 of the check valve 58 when the check valve 58 is sealed thereto. For instance, the end point 86 may be rounded in shape, although other forms and shapes are envisioned herein.

As illustrated in FIGS. 1-7, the cartridge sealing ring 76 is longitudinally spaced away from the base plate sealing ring 74 to form a second gap G2 therebetween. The second gap G2 may have a width measurement W2 of between approximately 0.060 and 0.150 inches (or 3.8 mm), although other measurements are envisioned herein. The second gap G2 is an opening below the check valve 58 through which fluid flowing into the openings 66 of the base plate 36 can flow after entering the filter assembly 20. The second gap G2 is connected to the first gap G1 such that a flow passageway P extends between the gaps G1 and G2 that fluid can flow through. In illustrative embodiments, the second gap G2 is upstream of the angled portion 92 of the check valve 58, as illustrated in FIGS. 4A-6B. Accordingly, when fluid is flowing through the passageway P and exits the gap G1, the fluid takes a bypass path B that bypasses the filter element 28. Further, such fluid will enter the second gap G2 before subjecting the angled portion 92 of the check valve 58 to pressure from the fluid, reducing unnecessary wear and tear on the check valve 58.

In illustrative embodiments, the centering portion 72 of the valve seat 60 includes one or more annular walls 42 that extend upward from the connector portion 73 and are annular to the longitudinal axis A of the valve seat 60. The annular walls 42 may illustratively be substantially perpendicular to the seat portion 70, but other embodiments are envisioned herein. As illustrated, for example, in FIG. 7, the annular walls 42 may be slightly angled with respect to the longitudinal axis A to form an angle that is less than 90 degrees to the seat portion 70. The annular walls 42 include an outside surface 41 from which the connector portion 73 extends to connect to the seat portion 70. In various embodiments, the annular walls 42 of the centering portion 72 extend through the central aperture of the check valve 58, and the outside surface 41 of the annular walls 42 may abut against the end point 71 of the horizontal segment 90 of the check valve 58. In illustrative embodiments, the annular walls 42 may have a length that may be between 0.500 inches and 1.000 inches, although other lengths are envisioned herein.

An outflow aperture 100 extends along the longitudinal axis A of the valve seat 60. The outflow aperture 100 extends within the circumference of the annular walls 42 of the centering portion 72 and further extends through the seat portion 70 to provide a flow path for fluid flowing to the outlet opening 80 of the filter assembly 20. Accordingly, fluid that has been filtered through the filter element 28 and flows into the opening 31, or fluid that has by-passed the filter element 28 via the check valve 58 and relief valve seat assembly 56, is directed to pass through the flow aperture 100 of the valve seat 60 to the outlet opening 80.

The annular walls 42 of the valve seat 60 are spaced apart to form one or more bypass apertures 102. The bypass apertures 102 are configured to permit fluid to flow into the outflow aperture 100 from the gap G1. In various embodiments, and as illustrated in FIGS. 1 and 2, the bypass apertures 102 may be spaced equally around the circumference of the valve seat 60. In illustrative embodiments, the bypass apertures 102 may be positioned to at least partially be aligned longitudinally above one or more gaps G1 between the check valve sealing ring 78 and the cartridge sealing ring 76 of the seat portion 70 of the valve seat 60. In various embodiments, the bypass apertures 102 extend into the connector portion 73 between the seat and centering portions 70 and 72 of the relief valve, and may further extend into a portion of the check valve sealing ring 78, as illustrated in FIG. 1. In such a configuration, fluid flowing through the gap G1 between the check valve sealing ring 78 and the cartridge sealing ring 76 may flow substantially horizontally into the bypass apertures 102 when the check valve 58 is not sealed against the check valve sealing ring 78.

The centering portion 72 further includes one or more outwardly-protruding tangs 44 that are coupled to a top end of the annular walls 42. The tangs 44 may be sized and shaped in various embodiments. In an illustrative embodiment, the tangs 44 are configured to extend annularly outwardly from the outside surface 41 of the annular walls 42 and include a stop surface 43 that is substantially perpendicular to the outside surface 41 of the annular walls 42, as illustrated in FIG. 7. In certain configurations, the stop surface 43 of the tang 44, the outside surface 41 of the annular walls 42, and the top surface 79 of the check valve sealing ring 78 form a retainment gap 47 therebetween. The retainment gap 47 may retain the biasing member 64, as described herein. In illustrative embodiments, the tangs 44 may have a length that may be between 0.125 inches and 0.200 inches, although other lengths are envisioned herein.

In illustrative embodiments, the valve seat 60 of the relief valve seat assembly 56 may be composed of two or more separate structures that make up the components of the valve seat 60. The components of the valve seat 60 may be separated in various ways, which will now be described herein, and the coupled together to form the valve seat (for instance, before or during manufacturing or assembly of the filter assembly 20). Specifically, alternative embodiments of a two-piece valve seat 260/360/460 that may be incorporated into the relief valve seat assembly 56 will be described herein; however, similar reference numerals will be used to identify and describe similar structures as described above regarding the valve seat 60. Separation of the structures of the two-piece valve seat 260 may provide manufacturing efficiencies and reduction of costs for production of the valve seat, for example, as compared to a unitary relief valve seat structure. While components of a two-piece relief valve seat are described herein, such components may be further separated into a larger number of pieces and be considered within the scope of this disclosure.

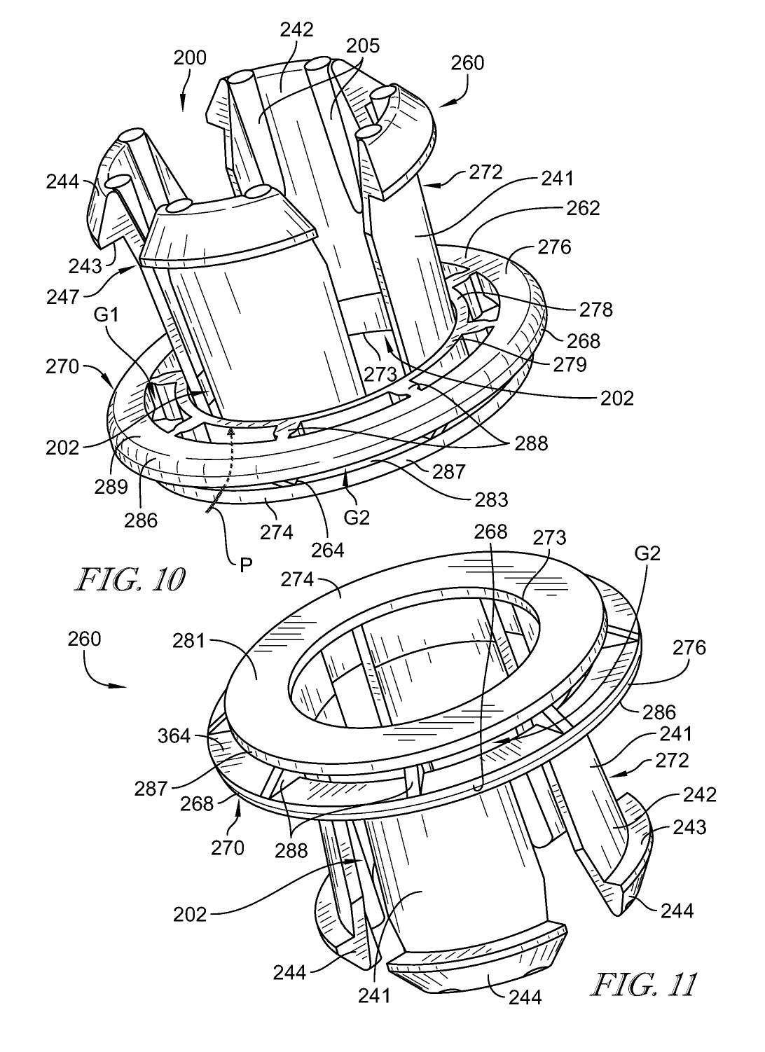

A first alternative two-piece valve seat 260 for incorporation into the relief valve seat assembly 56 is illustrated in FIGS. 10-12. As illustrated, the two-piece valve seat 260 illustratively includes a seating portion 270 and a separate centering portion 272 that can be coupled to the seating portion 270 via, for example, a snap retainment. Alternatively, the seating portion 270 may be retained upon the centering portion 272 by resting upon an annular bottom ledge 274, described below, that extends radially outward from the centering portion 272.

Both the seating portion 270 and centering portion 272 may be annular in nature to the longitudinal axis 82 when the two-piece valve seat 260 is incorporated into the filter assembly 20. The seating portion 270 may be generally horizontal in direction (that is, perpendicular to the longitudinal axis 82) and the centering portion 272 may be aligned to be generally vertical in direction (that is, parallel to the longitudinal axis 82). In various embodiments, the seating and centering portions 270 and 272 may be made of rubber, plastic, an elastomeric material, or any other suitable material. For instance, the seating and centering portions 270 and 272 may be formed of nylon or a silicone-based or silicon-like material, although other materials are also envisioned herein. In illustrative embodiments, one or more components of the two-piece valve seat 260 may be formed of nylon, such as Nylon6, Nylon 6/6 or Nylon12. Any material that may be injection-molded or extruded and can withstand the environment of an oil filter may be used.

In various embodiments, the seating portion 270 of the two-piece valve seat 260 includes a cartridge sealing ring 276, a check valve sealing ring 278, and one or more connection bridges 288 extending between the cartridge sealing ring 276 and the check valve sealing ring 278, as illustrated in FIGS. 10-12. The seating portion 270 includes a top surface 262, a bottom surface 264, an inner surface 266, and an outer surface 268. A portion of the check valve sealing ring 278 defines the inner surface 266, with the inner surface 266 forming the inner periphery of the seating portion 270. A portion of the cartridge sealing ring 276 defines the outer surface 268, with the outer surface 268 forming the outer periphery of the seating portion 270. In various embodiments, the inner surface 266 is configured to be positioned adjacent a portion of the centering portion 272 when the seating portion 270 is assembled with the centering portion 272.

In illustrative embodiments, the check valve sealing ring 278 may extend along a plane that is generally perpendicular to the longitudinal axis A of the relief valve seat assembly 56. As understood from the description above, the check valve sealing ring 278 is configured to provide a sealing surface for the check valve 58 to seat against when the two-piece valve seat 260 is aligned within the central aperture of the check valve 58 along the longitudinal axis 82 of the filter assembly 20. Illustratively, a bottom surface 59 of the check valve 58 is configured to abut against a top surface 279 of the check valve sealing ring 278 to seal the check valve 58 to the two-piece valve seat 260 to prevent fluid flow therebetween. Such sealing may occur at or near the end point 71 of the check valve 58, although other locations are envisioned herein.

In illustrative embodiments, the cartridge sealing ring 276 is configured to extend annularly outward of the check valve sealing ring 278. In certain embodiments, the cartridge sealing ring 276 is generally aligned with the plane of the check valve sealing ring 278 but is annularly spaced away from the check valve sealing ring 278 by a first gap G1 that can permit fluid to flow between the check valve sealing ring 278 and the cartridge sealing ring 276, as illustrated in FIG. 10. As noted, the cartridge sealing ring 276 may be coupled to the check valve sealing ring 278 by one or more connection bridges 288 that extend outwardly from the check valve sealing ring 278 to retain the cartridge sealing ring 276 to the check valve sealing ring 278. In various embodiments, the connection bridges 288 may be equally spaced apart around the circumference of the check valve sealing ring 278, although other embodiments are envisioned herein. Illustratively, there may be 8 equally spaced apart connection bridges 288 in the two-piece valve seat 260.

In various embodiments, a top surface 289 of the cartridge sealing ring 276 is aligned horizontally with the top surface 279 of the check valve sealing ring 278. Accordingly, the check valve sealing ring 278 and the cartridge sealing ring 276 are generally parallel to each other and provide two parallel surfaces 279 and 289 upon which the bottom surface 59 of the check valve 58 can abut against to seal the check valve 58 to the two-piece valve seat 260 to prevent fluid flow through the gap G1. The cartridge sealing ring 276 terminates at an end point 286. In illustrative embodiments, the end point 286 may be complimentarily shaped to be received in the bend 94 of the check valve 58 when the check valve 58 is sealed thereto. For instance, the end point 286 may be rounded in shape, although other forms and shapes are envisioned herein.

As illustrated in FIGS. 10-12, the cartridge sealing ring 276 of the seating portion 270 is longitudinally spaced away from the base plate sealing ring 274 of the centering portion 272 to form a second gap G2 therebetween. The second gap G2 is an opening below the check valve 58 through which fluid flowing into the openings 66 of the base plate 36 can flow after entering the filter assembly 20. The second gap G2 is connected to the first gap G1 such that a flow passageway P extends between the gaps G1 and G2 that fluid can flow through. In illustrative embodiments, the second gap G2 is upstream of the angled portion 92 of the check valve 58. Accordingly, when fluid is flowing through the passageway P and exits the gap G1, the fluid takes a bypass path B that bypasses the filter element 28. Further, such fluid will enter the second gap G2 before subjecting the angled portion 92 of the check valve 58 to pressure from the fluid, reducing unnecessary wear and tear on the check valve 58.

In illustrative embodiments, the centering portion 272 of the two-piece valve seat 260 includes an annular bottom ledge 274 that functions as a base plate sealing ring. The base plate sealing ring 274 is configured to extend annularly outward of and below seating portion 270, and in particular outward and below the check valve sealing ring 278, as illustrated in FIG. 10. The base plate sealing ring 274 may extend outward from an outside surface 241 of the centering portion 272 at a point 273 and be configured to extend in a substantially perpendicular direction from the alignment of the centering portion 272 and the longitudinal axis A of the relief valve seat assembly 56. The base plate sealing ring 274 may extend along a second plane that is substantially parallel to the plane of the check valve sealing ring 278, but the base plate sealing ring 274 may extend below the check valve sealing ring 278, to create a horizontal gap between the base plate sealing ring 74 and the check valve sealing ring 278. The base plate sealing ring 274 includes a bottom surface 281 and a top surface 283 and terminates at an end point 287 that is opposite to the point 273 from where the base plate sealing ring 274 extends from the outside surface 241 of the centering portion 272. In various embodiments, the cartridge sealing ring 276 may extend further annularly outward of the base plate sealing ring 274 when the centering portion 272 is coupled to the seating portion 270.

In illustrative embodiments, the centering portion 272 of the two-piece valve seat 260 further includes one or more annular walls 242 that extend upward from the base plate sealing ring 274 and are annular to the longitudinal axis A of the two-piece valve seat 260. The annular walls 242 may illustratively be substantially perpendicular to the base plate sealing ring 274, but other embodiments are envisioned herein. In an illustrative embodiment, the annular walls 242 may include or more ribs 205 that provide structural support for the centering portion 272 during manufacturing and/or assembly within the filter assembly 20.

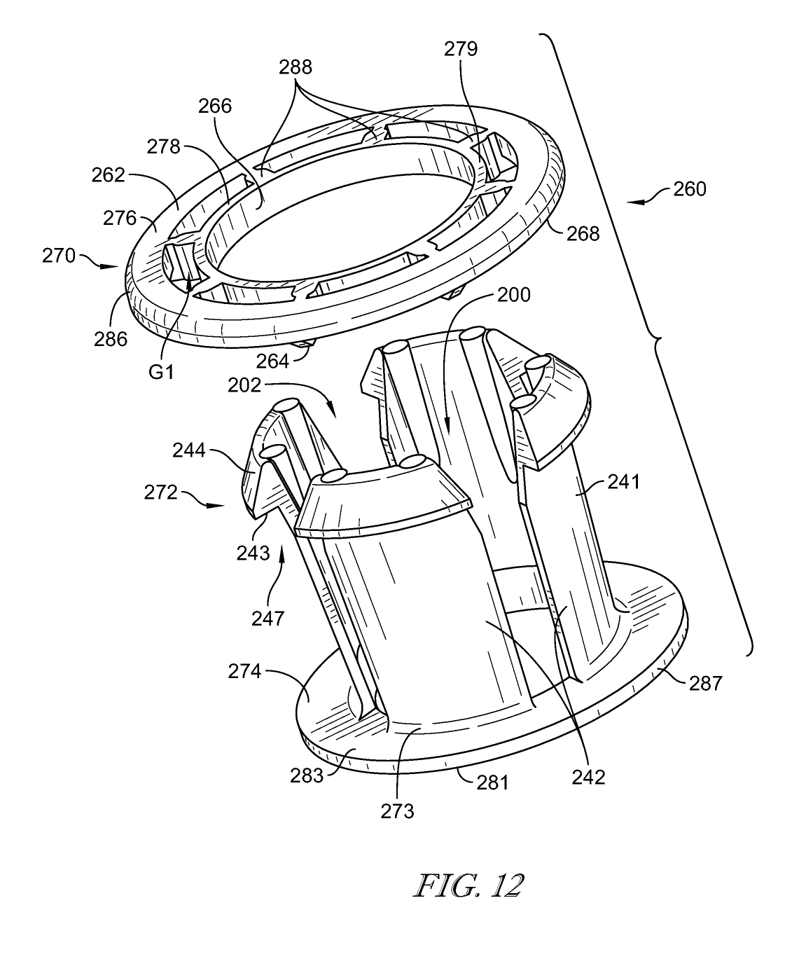

As illustrated, for example, in FIGS. 10 and 12, at least a portion of the annular walls 242 may be slightly angled with respect to the longitudinal axis A to form an angle that is less than 90 degrees to the base plate sealing ring 274 in order to, for example, provide structural support or assistance for positioning of the centering portion 272 within the filter assembly 20. The annular walls 242 include the outside surface 241 from which the base plate sealing ring 274 extend. In various embodiments, the annular walls 242 of the centering portion 272 extend through the central aperture of the check valve 58, and the outside surface 241 of the annular walls 242 may abut against the end point 71 of the horizontal segment 90 of the check valve 58. In illustrative embodiments, the annular walls 242 may have a length that may be between 0.500 inches and 1.000 inches, although other lengths are envisioned herein.

An outflow aperture 200 extends along the longitudinal axis A of the two-piece valve seat 260. The outflow aperture 200 extends within the circumference of the annular walls 242 of the centering portion 272 to provide a flow path for fluid flowing to the outlet opening 80 of the filter assembly 20. Accordingly, fluid that has been filtered through the filter element 28 and flows into the opening 31, or fluid that has by-passed the filter element 28 via the check valve 58 and relief valve seat assembly 56, is directed to pass through the outflow aperture 200 of the two-piece valve seat 260 to the outlet opening 80.

The annular walls 242 of the two-piece valve seat 260 are spaced apart to form one or more bypass apertures 202. The bypass apertures 202 are configured to permit fluid to flow into the outflow aperture 200 from the gap G1. In various embodiments, and as illustrated in FIGS. 10-12, the bypass apertures 202 may be spaced equally around the circumference of the two-piece valve seat 260. In illustrative embodiments, the bypass apertures 202 may be positioned to at least partially be aligned longitudinally above one or more gaps G1 between the check valve sealing ring 278 and the cartridge sealing ring 276 of the seating portion 270 of the two-piece valve seat 260. In various embodiments, the bypass apertures 202 extend to the connection point 273 for the base plate sealing ring 274, as illustrated in FIG. 12. In such a configuration, fluid flowing through the gap G1 between the check valve sealing ring 278 and the cartridge sealing ring 276 may flow substantially horizontally into the bypass apertures 202 when the check valve 58 is not sealed against the check valve sealing ring 278.

The centering portion 272 further includes one or more outwardly-protruding tangs 244 that are coupled to a top end of the annular walls 242. The tangs 244 may be sized and shaped in various embodiments. In an illustrative embodiment, the tangs 244 are configured to extend annularly outwardly from the outside surface 241 of the annular walls 242 and include a stop surface 243 that is substantially perpendicular to the outside surface 241 of the annular walls 242, as illustrated in FIG. 12. In certain configurations, the stop surface 243 of the tang 244, the outside surface 241 of the annular walls 242, and the top surface 279 of the check valve sealing ring 278 form a retainment gap 247 therebetween. The retainment gap 247 may retain the biasing member 64, as described herein. In illustrative embodiments, the tangs 244 may have a length that may be between 0.125 inches and 0.200 inches, although other lengths are envisioned herein.

In illustrative embodiments, the connection bridges 288 of the seating portion 270 are configured to extend below the cartridge sealing ring 276 and check valve sealing ring 278 along the longitudinal axis 82. Accordingly, the connection bridges 288 define the bottom surface 264 of the seating portion 270. In illustrative embodiments, the bottom surface 264 is configured to abut or rest upon the top surface 283 of the base plate sealing ring 274 when the seating portion 270 is coupled together with the centering portion 272 to form the two-piece valve seat 260. Similarly, the inner surface 266 of the seating portion 270 may be configured to abut against the outside surface 241 of the centering portion 272 when the seating portion 270 is coupled together with the centering portion 272.

As noted, the two-piece valve seat 260 may be assembled via a snap-lock method, wherein one or more of the components are snapped together to be retained within the relief valve seat assembly 56. Similarly, the components of the relief valve seat assembly 56, and the fluid flow control assembly 54, may be snapped together to be retained together. Accordingly, the present disclosure encompasses a fluid flow control assembly 54 that requires no seaming, welding, melting or applied glue to be assembled. Assembly can happen prior to installation of the fluid flow control assembly 54 within the housing 22.

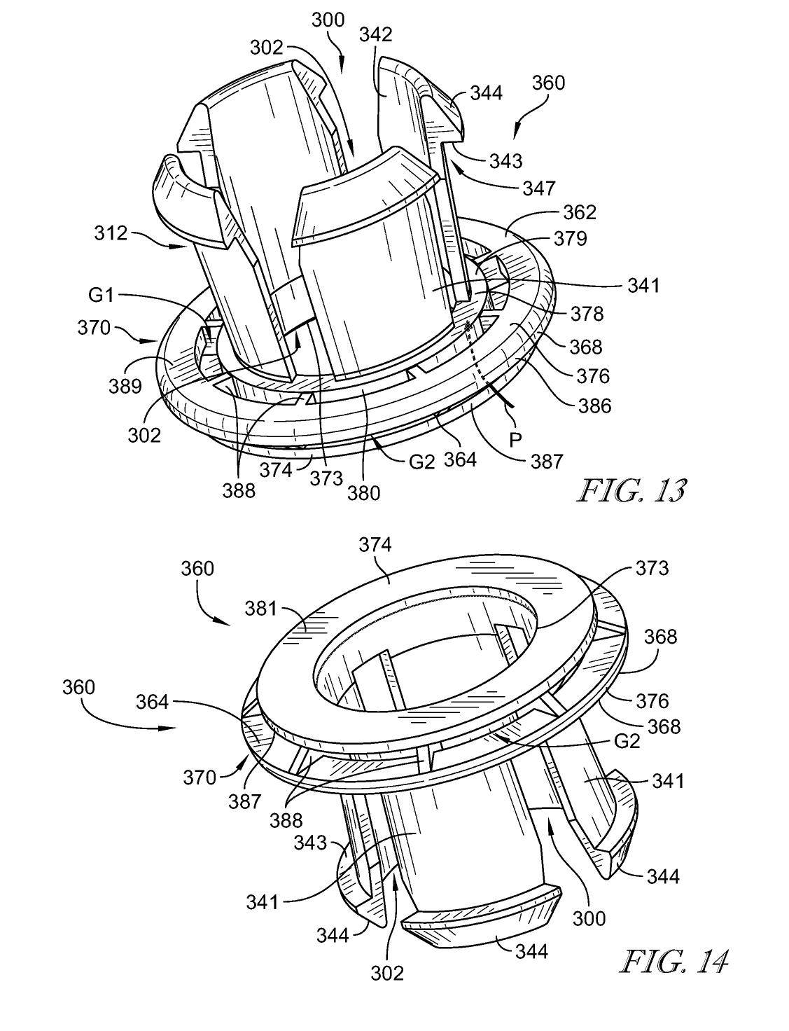

A second alternative two-piece valve seat 360 for incorporation into the relief valve seat assembly 56 is illustrated in FIGS. 13-15. As illustrated, the two-piece valve seat 360 illustratively includes a cartridge seating portion 370 and a centering-and-valve-sealing portion 372 that can be coupled to the cartridge seating portion 370 via, for example, a snap retainment. Alternatively, the cartridge seating portion 370 may be retained upon the centering-and-valve-sealing portion 372 by resting upon an annular bottom ledge 374, described below, that extends radially outward from the centering-and-valve-sealing portion 372.

Both the cartridge seating portion 370 and centering-and-valve-sealing portion 372 may be annular in nature to the longitudinal axis 82 when the two-piece valve seat 360 is incorporated into the filter assembly 20. The cartridge seating portion 370 may be generally horizontal in direction (that is, perpendicular to the longitudinal axis 82) and the centering-and-valve-sealing portion 372 may be aligned to be generally vertical in direction (that is, parallel to the longitudinal axis 82). In various embodiments, the two portions 370 and 372 may be made of rubber, plastic, an elastomeric material, or any other suitable material. For instance, the portions 370 and 372 may be formed of nylon or a silicone-based or silicon-like material, although other materials are also envisioned herein. In illustrative embodiments, one or more components of the two-piece valve seat 360 may be formed of nylon, such as Nylon6, Nylon 6/6 or Nylon12. Any material that may be injection-molded or extruded and can withstand the environment of an oil filter may be used.

In various embodiments, the cartridge seating portion 370 of the two-piece valve seat 360 includes a cartridge sealing ring 376 and one or more connection bridges 388 extending radially inward from the cartridge sealing ring 376, as illustrated in FIGS. 13-15. The cartridge seating portion 370 includes a top surface 362, a bottom surface 364, an inner surface 366, and an outer surface 368. The one or more connection bridges 388 each include an inner surface 365 that defines the inner surface 366 of the cartridge seating portion 370. An end point 386 of the cartridge sealing ring 376 defines the outer surface 368, with the outer surface 368 forming the outer periphery of the cartridge seating portion 370. In various embodiments, the inner surface 366 is configured to be positioned adjacent a portion of the centering-and-valve-sealing portion 372 when the cartridge seating portion 370 is assembled with the centering-and-valve-sealing portion 372, as described below.

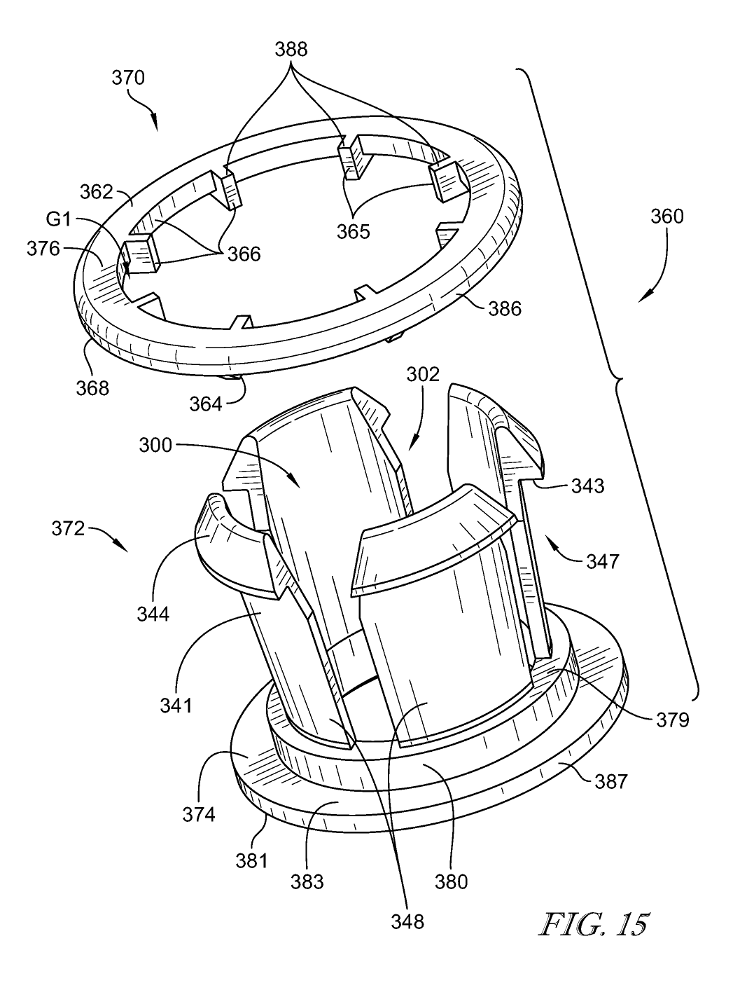

In illustrative embodiments, the centering-and-valve-sealing portion 372 of the two-piece valve seat 360 includes an annular bottom ledge 374 and a check valve sealing ring 378, as illustrated in FIG. 15. The annular bottom ledge 374 functions as a base plate sealing ring 374. The base plate sealing ring 374 is configured to extend annularly outward of and below a portion of cartridge seating portion 370 when assembled together, as illustrated in FIG. 13. The base plate sealing ring 374 may extend outward from an exterior surface 341 of the centering-and-valve-sealing portion 372 at an end point 373 of the exterior surface 341 and be configured to extend in a substantially perpendicular direction from the alignment of the centering-and-valve-sealing portion 372 and the longitudinal axis A of the relief valve seat assembly 56. The base plate sealing ring 374 includes a bottom surface 381 and a top surface 383 and terminates at an end point 387 that is opposite to the point 373 from where the base plate sealing ring 374 extends from the exterior surface 341 of the centering-and-valve-sealing portion 372.

As illustrated in FIG. 15, the check valve sealing ring 378 of the centering-and-valve-sealing portion 372 is positioned adjacent to and above the base plate sealing ring 374. The check valve sealing ring also extends radially outward of the exterior surface 341 of the centering-and-valve-sealing portion 372. The check valve sealing ring 378 includes a top surface 379 that extends in a plane that a substantially perpendicular direction from the exterior surface 341. The check valve sealing ring 378 further includes an outer circumference surface 380 that extends substantially parallel to the exterior surface 341. The base plate sealing ring 374 extends further in a radial direction away from the longitudinal axis 82 than the check valve sealing ring 378, as illustrated. The length or width of the top surface 379 and outer circumference surface 380 can vary within the scope of disclosure. An illustrative embodiment of the length of the top surface 379 may be anywhere between 0.05 inches and 0.10 inches.

In illustrative embodiments, the cartridge sealing ring 376 of the cartridge seating portion 370 is configured to extend annularly outward of the check valve sealing ring 378 of the centering-and-valve-sealing portion 372 when assembled together. In certain embodiments, the top surface 362 of the cartridge sealing ring 376 is generally aligned along the plane of the top surface 379 of the check valve sealing ring 378 when assembled together. However, when the cartridge seating portion 370 is coupled to the centering-and-valve-sealing portion 372, the cartridge sealing ring 376 is annularly spaced away from the check valve sealing ring 378 by a first gap G1 that can permit fluid to flow between the check valve sealing ring 378 and the cartridge sealing ring 376, as illustrated in FIG. 13. According, when coupled together, the outer circumference surface 380 of the check valve sealing ring 378 of the centering-and-valve-sealing portion 372 may abut against the inner surface 365 of the one or more connection bridges 388 that extend inwardly from the cartridge sealing ring 376. In various embodiments, the connection bridges 388 may be equally spaced apart around the circumference of the cartridge seating portion 370, although other embodiments are envisioned herein. Illustratively, there may be eight equally spaced apart connection bridges 388 in the two-piece valve seat 360.

As noted, in various embodiments, the top surface 362 of the cartridge sealing ring 376 is aligned horizontally with the top surface 379 of the check valve sealing ring 378 when the cartridge seating portion 370 is coupled to the centering-and-valve-sealing portion 372. Accordingly, the check valve sealing ring 378 and the cartridge sealing ring 376 are generally parallel to each other and provide two parallel surfaces 379 and 362 upon which the bottom surface 59 of the check valve 58 can abut against to seal the check valve 58 to the two-piece valve seat 360 to prevent fluid flow through the gap G1. The cartridge sealing ring 376 terminates at an end point 386. In illustrative embodiments, the end point 386 may be complimentarily shaped to be received in the bend 94 of the check valve 58 when the check valve 58 is sealed thereto. For instance, the end point 386 may be rounded in shape, although other forms and shapes are envisioned herein.

As illustrated in FIGS. 13-15, the cartridge sealing ring 376 of the cartridge seating portion 370 is configured to be longitudinally spaced away from the base plate sealing ring 374 to form a second gap G2 therebetween when the cartridge seating portion 370 is coupled to the centering-and-valve-sealing portion 372. The second gap G2 is an opening below the check valve 58 through which fluid flowing into the openings 66 of the base plate 36 can flow after entering the filter assembly 20. The second gap G2 is connected to the first gap G1 such that a flow passageway P extends between the gaps G1 and G2 that fluid can flow through. In illustrative embodiments, the second gap G2 is upstream of the angled portion 92 of the check valve 58. Accordingly, when fluid is flowing through the passageway P and exits the gap G1, the fluid takes a bypass path B that bypasses the filter element 28. Further, such fluid will enter the second gap G2 before subjecting the angled portion 92 of the check valve 58 to pressure from the fluid, reducing unnecessary wear and tear on the check valve 58.

In various embodiments, the cartridge sealing ring 376 may extend further annularly outward of the base plate sealing ring 374 when the centering-and-valve-sealing portion 372 is coupled to the cartridge seating portion 370. The base plate sealing ring 374 may extend along a second plane that is substantially parallel to the plane of the check valve sealing ring 378 and cartridge sealing ring 376, but the base plate sealing ring 374 may extend below the check valve sealing ring 378 and cartridge sealing ring 376 to create a horizontal gap between the base plate sealing ring 74 and the check valve sealing ring 378.

In illustrative embodiments, the centering-and-valve-sealing portion 372 of the two-piece valve seat 360 further includes one or more annular walls 342 that extend upward from the base plate sealing ring 374 and are annular to the longitudinal axis A of the two-piece valve seat 360. The annular walls 342 may illustratively be substantially perpendicular to the base plate sealing ring 374, but other embodiments are envisioned herein. The annular walls 342 may define the exterior surface 341 from which the base plate sealing ring 374 and the check valve sealing ring 378 extend.

As illustrated, for example, in FIGS. 13 and 15, at least a portion of the annular walls 342 may be slightly angled with respect to the longitudinal axis A to form an angle that is less than 90 degrees to the base plate sealing ring 374 in order to, for example, provide structural support or assistance for positioning of the centering-and-valve-sealing portion 372 within the filter assembly 20. In various embodiments, the annular walls 342 of the centering-and-valve-sealing portion 372 extend through the central aperture of the check valve 58, and the exterior surface 341 of the annular walls 342 may abut against the end point 71 of the horizontal segment 90 of the check valve 58. In illustrative embodiments, the annular walls 342 may have a length that may be between 0.500 inches and 1.000 inches, although other lengths are envisioned herein.

An outflow aperture 300 extends along the longitudinal axis A of the two-piece valve seat 360. The outflow aperture 300 extends within the circumference of the annular walls 342 of the centering-and-valve-sealing portion 372 to provide a flow path for fluid flowing to the outlet opening 80 of the filter assembly 20. Accordingly, fluid that has been filtered through the filter element 28 and flows into the opening 31, or fluid that has by-passed the filter element 28 via the check valve 58 and relief valve seat assembly 56, is directed to pass through the outflow aperture 300 of the two-piece valve seat 360 to the outlet opening 80.

The annular walls 342 of the two-piece valve seat 360 are spaced apart to form one or more bypass apertures 302. The bypass apertures 302 are configured to permit fluid to flow into the outflow aperture 300 from the gap G1. In various embodiments, and as illustrated in FIGS. 13-15, the bypass apertures 302 may be spaced equally around the circumference of the two-piece valve seat 360. In illustrative embodiments, the bypass apertures 302 may be positioned to at least partially be aligned longitudinally above one or more gaps G1 between the check valve sealing ring 378 and the cartridge sealing ring 376 of the cartridge seating portion 370 of the two-piece valve seat 360. In such a configuration, fluid flowing through the gap G1 between the check valve sealing ring 378 and the cartridge sealing ring 376 may flow substantially horizontally into the bypass apertures 302 when the check valve 58 is not sealed against the check valve sealing ring 378. In other illustrative embodiments, the bypass apertures 302 may be positioned adjacent to or above one or more connection bridges 388 in the two-piece valve seat 360.

The centering-and-valve-sealing portion 372 further includes one or more outwardly-protruding tangs 344 that are coupled to a top end of the annular walls 342. The tangs 344 may be sized and shaped in various embodiments. In an illustrative embodiment, the tangs 344 are configured to extend annularly outwardly from the exterior surface 341 of the annular walls 342 and include a stop surface 343 that is substantially perpendicular to the exterior surface 341 of the annular walls 342, as illustrated in FIG. 15. In certain configurations, the stop surface 343 of the tang 344, the exterior surface 341 of the annular walls 342, and the top surface 379 of the check valve sealing ring 378 form a retainment gap 347 therebetween. The retainment gap 347 may retain the biasing member 64, as described herein. In illustrative embodiments, the tangs 344 may have a length that may be between 0.125 inches and 0.300 inches, although other lengths are envisioned herein.

In illustrative embodiments, the connection bridges 388 of the cartridge seating portion 370 are configured to be positioned below the cartridge sealing ring 376 and check valve sealing ring 378 along the longitudinal axis 82. The connection bridges 388 may define the bottom surface 364 of the cartridge seating portion 370. In illustrative embodiments, the bottom surface 364 is configured to abut or rest upon the top surface 383 of the base plate sealing ring 374 when the seating portion 370 is coupled together with the centering-and-valve-sealing portion 372 to form the two-piece valve seat 360. Similarly, the inner surface 366 of the cartridge seating portion 370 may be configured to abut against the outer circumference surface 380 of the check valve sealing ring 378 when the seating portion 370 is coupled together with the centering-and-valve-sealing portion 372.

As noted, the two-piece valve seat 360 may be assembled via a snap-lock method, wherein one or more of the components are snapped together to be retained within the relief valve seat assembly 56. Similarly, the components of the relief valve seat assembly 56, and the fluid flow control assembly 54, may be snapped together to be retained together. Accordingly, the present disclosure encompasses a fluid flow control assembly 54 that requires no seaming, welding, melting or applied glue to be assembled. Assembly can happen prior to installation of the fluid flow control assembly 54 within the housing 22.

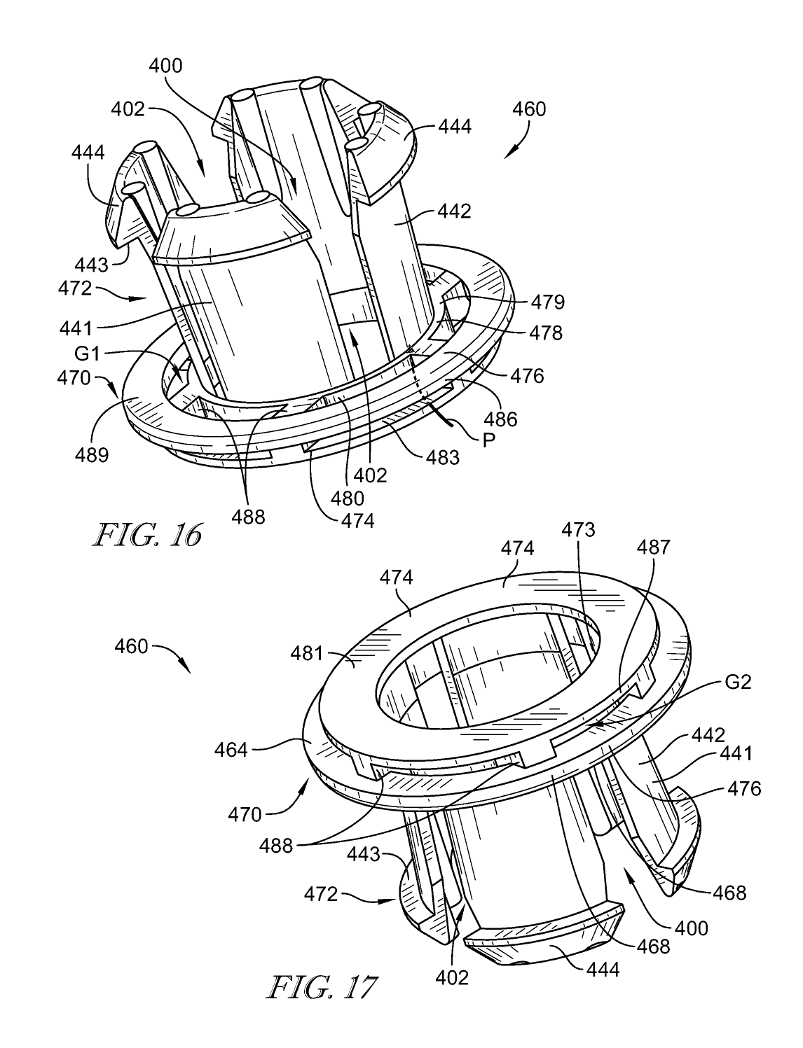

A third alternative two-piece valve seat 460 for incorporation into the relief valve seat assembly 56 is illustrated in FIGS. 16-18. As illustrated, the two-piece valve seat 460 illustratively includes a cartridge seating portion 470 and a centering-and-valve-sealing portion 472 that can be coupled to the cartridge seating portion 470 via, for example, a snap retainment. Alternatively, the cartridge seating portion 470 may be retained upon the centering-and-valve-sealing portion 472 by resting on a portion of the centering-and-valve-sealing portion 472, described below.

Both the cartridge seating portion 470 and centering-and-valve-sealing portion 472 may be annular in nature to the longitudinal axis 82 when the two-piece valve seat 460 is incorporated into the filter assembly 20. The cartridge seating portion 470 may be generally horizontal in direction (that is, perpendicular to the longitudinal axis 82) and the centering-and-valve-sealing portion 472 may be aligned to be generally vertical in direction (that is, parallel to the longitudinal axis 82). In various embodiments, the two portions 470 and 472 may be made of rubber, plastic, an elastomeric material, or any other suitable material. For instance, the portions 470 and 472 may be formed of nylon or a silicone-based or silicon-like material, although other materials are also envisioned herein. In illustrative embodiments, one or more components of the two-piece valve seat 460 may be formed of nylon, such as Nylon6, Nylon 6/6 or Nylon12. Any material that may be injection-molded or extruded and can withstand the environment of an oil filter may be used.

In various embodiments, the cartridge seating portion 470 of the two-piece valve seat 460 includes a cartridge sealing ring 476, as illustrated in FIGS. 13-15. The cartridge seating portion 470 includes a top surface 462, a bottom surface 464, an inner surface 466, and an outer surface 468. The outer surface 468 extends to an end point 486, with the outer surface 468 forming the outer periphery of the cartridge seating portion 470. In various embodiments, the inner surface 466 is configured to be positioned adjacent a portion of the centering-and-valve-sealing portion 472 when the cartridge seating portion 470 is assembled with the centering-and-valve-sealing portion 472, as described below.

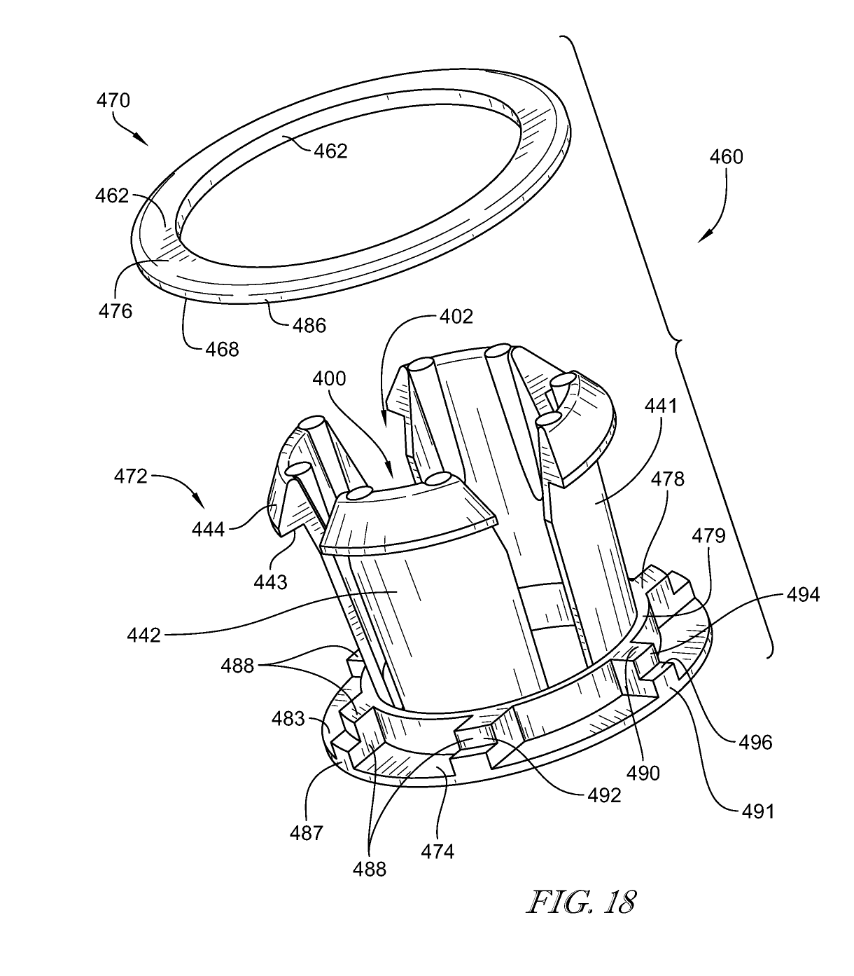

In illustrative embodiments, the centering-and-valve-sealing portion 472 of the two-piece valve seat 460 includes an annular bottom ledge 474, a check valve sealing ring 478, and one or more connection bridges 488, as illustrated in FIG. 18. The annular bottom ledge 474 functions as a base plate sealing ring 474. The base plate sealing ring 474 is configured to extend annularly outward of and below a portion of cartridge seating portion 470 when assembled together, as illustrated in FIG. 16. The base plate sealing ring 474 may extend outward from an exterior surface 441 of the centering-and-valve-sealing portion 472 at an end point 473 of the exterior surface 441 and be configured to extend in a substantially perpendicular direction from the alignment of the centering-and-valve-sealing portion 472 and the longitudinal axis A of the relief valve seat assembly 56. The base plate sealing ring 474 includes a bottom surface 481 and a top surface 483 and terminates at an end point 487 that is opposite to the point 473 from where the base plate sealing ring 474 extends from the exterior surface 441 of the centering-and-valve-sealing portion 472.

As illustrated in FIG. 18, the check valve sealing ring 478 of the centering-and-valve-sealing portion 472 is positioned adjacent to and above the base plate sealing ring 474. The check valve sealing ring also extends radially outward of the exterior surface 441 of the centering-and-valve-sealing portion 472. The check valve sealing ring 478 includes a top surface 479 that extends in a plane that a substantially perpendicular direction from the exterior surface 441. The check valve sealing ring 478 further includes an outer circumference surface 480 that extends substantially parallel to the exterior surface 441. The base plate sealing ring 474 extends further in a radial direction away from the longitudinal axis 82 than the check valve sealing ring 478, as illustrated. The length or width of the top surface 479 and outer circumference surface 480 can vary within the scope of disclosure. An illustrative embodiment of the length of the top surface 479 may be anywhere between 0.05 inches and 0.10 inches.

The one or more connection bridges 488 of the centering-and-valve-sealing portion 472 are configured to extend radially outward from the outer circumference surface 480 of the check valve sealing ring 478, as illustrated in FIG. 18. In various embodiments, the connection bridges 488 include at least a top surface 490, an exterior surface 491, and a ledge 492. The ledge 492 formed by a vertical surface 494 and a horizontal surface 496 that are substantially perpendicular to each other. As illustrated in FIG. 18, the ledge 492 may be positioned adjacent the exterior surface 491 of the connection bridge 488, and may be formed to receive a portion of the cartridge sealing ring 476 when the cartridge seating portion 470 is coupled to the centering-and-valve-sealing portion 472. The ledge 492 may accordingly act as a seat to receive the cartridge sealing ring 476 and facilitate proper alignment between the components of the two-piece valve seat 460. According, when coupled together, the inner surface 466 of the cartridge sealing ring 476 may abut against the horizontal surface 496 and/or vertical surface 494 of the ledges 492 of the one or more connection bridges 488 that extend outwardly from the check valve sealing ring 478. The exterior surface 491 of the connection bridges 488 may be positioned to be unitary with the end point 487 of the base plate sealing ring 474. In various embodiments, the connection bridges 488 may be equally spaced apart around the circumference of the cartridge seating portion 470, although other embodiments are envisioned herein. Illustratively, there may be eight equally spaced apart connection bridges 488 in the two-piece valve seat 460.

In illustrative embodiments, the cartridge sealing ring 476 of the cartridge seating portion 470 is configured to extend annularly outward of the check valve sealing ring 478 of the centering-and-valve-sealing portion 472 when assembled together. In certain embodiments, the top surface 462 of the cartridge sealing ring 476 is generally aligned along the plane of the top surface 479 of the check valve sealing ring 478 when assembled together. However, when the cartridge seating portion 470 is coupled to the centering-and-valve-sealing portion 472, the cartridge sealing ring 476 is annularly spaced away from the check valve sealing ring 478 by a first gap G1 that can permit fluid to flow between the check valve sealing ring 478 and the cartridge sealing ring 476, as illustrated in FIG. 16.

As noted, in various embodiments, the top surface 462 of the cartridge sealing ring 476 is aligned horizontally with the top surface 479 of the check valve sealing ring 478 when the cartridge seating portion 470 is coupled to the centering-and-valve-sealing portion 472. Accordingly, the check valve sealing ring 478 and the cartridge sealing ring 476 are generally parallel to each other and provide two parallel surfaces 479 and 462 upon which the bottom surface 59 of the check valve 58 can abut against to seal the check valve 58 to the two-piece valve seat 460 to prevent fluid flow through the gap G1. The cartridge sealing ring 476 terminates at an end point 486. In illustrative embodiments, the end point 486 may be complimentarily shaped to be received in the bend 94 of the check valve 58 when the check valve 58 is sealed thereto. For instance, the end point 486 may be rounded in shape, although other forms and shapes are envisioned herein.

As illustrated in FIGS. 16-18, the cartridge sealing ring 476 of the cartridge seating portion 470 is configured to be longitudinally spaced away from the base plate sealing ring 474 to form a second gap G2 therebetween when the cartridge seating portion 470 is coupled to the centering-and-valve-sealing portion 472. The second gap G2 is an opening below the check valve 58 through which fluid flowing into the openings 66 of the base plate 36 can flow after entering the filter assembly 20. The second gap G2 is connected to the first gap G1 such that a flow passageway P extends between the gaps G1 and G2 that fluid can flow through. In illustrative embodiments, the second gap G2 is upstream of the angled portion 92 of the check valve 58. Accordingly, when fluid is flowing through the passageway P and exits the gap G1, the fluid takes a bypass path B that bypasses the filter element 28. Further, such fluid will enter the second gap G2 before subjecting the angled portion 92 of the check valve 58 to pressure from the fluid, reducing unnecessary wear and tear on the check valve 58.

In various embodiments, the cartridge sealing ring 476 may extend further annularly outward of the base plate sealing ring 474 when the centering-and-valve-sealing portion 472 is coupled to the cartridge seating portion 470. The base plate sealing ring 474 may extend along a second plane that is substantially parallel to the plane of the check valve sealing ring 478 and cartridge sealing ring 476, but the base plate sealing ring 474 may extend below the check valve sealing ring 478 and cartridge sealing ring 476 to create a horizontal gap between the base plate sealing ring 74 and the check valve sealing ring 478.

In illustrative embodiments, the centering-and-valve-sealing portion 472 of the two-piece valve seat 460 further includes one or more annular walls 442 that extend upward from the base plate sealing ring 474 and are annular to the longitudinal axis A of the two-piece valve seat 460. The annular walls 442 may illustratively be substantially perpendicular to the base plate sealing ring 474, but other embodiments are envisioned herein. The annular walls 442 may define the exterior surface 441 from which the base plate sealing ring 474 and the check valve sealing ring 478 extend.

As illustrated, for example, in FIGS. 16 and 18, at least a portion of the annular walls 442 may be slightly angled with respect to the longitudinal axis A to form an angle that is less than 90 degrees to the base plate sealing ring 474 in order to, for example, provide structural support or assistance for positioning of the centering-and-valve-sealing portion 472 within the filter assembly 20. In various embodiments, the annular walls 442 of the centering-and-valve-sealing portion 472 extend through the central aperture of the check valve 58, and the exterior surface 441 of the annular walls 442 may abut against the end point 71 of the horizontal segment 90 of the check valve 58. In illustrative embodiments, the annular walls 442 may have a length that may be between 0.500 inches and 1.000 inches, although other lengths are envisioned herein.

An outflow aperture 400 extends along the longitudinal axis A of the two-piece valve seat 460. The outflow aperture 400 extends within the circumference of the annular walls 442 of the centering-and-valve-sealing portion 472 to provide a flow path for fluid flowing to the outlet opening 80 of the filter assembly 20. Accordingly, fluid that has been filtered through the filter element 28 and flows into the opening 31, or fluid that has by-passed the filter element 28 via the check valve 58 and relief valve seat assembly 56, is directed to pass through the outflow aperture 400 of the two-piece valve seat 460 to the outlet opening 80.

The annular walls 442 of the two-piece valve seat 460 are spaced apart to form one or more bypass apertures 402. The bypass apertures 402 are configured to permit fluid to flow into the outflow aperture 400 from the gap G1. In various embodiments, and as illustrated in FIGS. 16-18, the bypass apertures 402 may be spaced equally around the circumference of the two-piece valve seat 460. In illustrative embodiments, the bypass apertures 402 may be positioned to at least partially be aligned longitudinally above one or more gaps G1 between the check valve sealing ring 478 and the cartridge sealing ring 476 of the cartridge seating portion 470 of the two-piece valve seat 460. In such a configuration, fluid flowing through the gap G1 between the check valve sealing ring 478 and the cartridge sealing ring 476 may flow substantially horizontally into the bypass apertures 402 when the check valve 58 is not sealed against the check valve sealing ring 478. In other illustrative embodiments, the bypass apertures 402 may be positioned adjacent to or above one or more connection bridges 488 in the two-piece valve seat 460.

The centering-and-valve-sealing portion 472 further includes one or more outwardly-protruding tangs 444 that are coupled to a top end of the annular walls 442. The tangs 444 may be sized and shaped in various embodiments. In an illustrative embodiment, the tangs 444 are configured to extend annularly outwardly from the exterior surface 441 of the annular walls 442 and include a stop surface 443 that is substantially perpendicular to the exterior surface 441 of the annular walls 442, as illustrated in FIG. 18. In certain configurations, the stop surface 443 of the tang 444, the exterior surface 441 of the annular walls 442, and the top surface 479 of the check valve sealing ring 478 form a retainment gap 447 therebetween. The retainment gap 447 may retain the biasing member 64, as described herein. In illustrative embodiments, the tangs 444 may have a length that may be between 0.125 inches and 0.400 inches, although other lengths are envisioned herein.

In illustrative embodiments, the connection bridges 488 of the cartridge seating portion 470 are configured to be positioned below the cartridge sealing ring 476 along the longitudinal axis 82. In illustrative embodiments, the connection bridges 488 are configured to extend upward from the top surface 483 of the base plate sealing ring 474. In further illustrative embodiments, the top surface 490 of the connection bridges 488 may be aligned with or unitary with the top surface 479 of the check valve sealing ring 478.

As noted, the two-piece valve seat 460 may be assembled via a snap-lock method, wherein one or more of the components are snapped together to be retained within the relief valve seat assembly 56. Similarly, the components of the relief valve seat assembly 56, and the fluid flow control assembly 54, may be snapped together to be retained together. Accordingly, the present disclosure encompasses a fluid flow control assembly 54 that requires no seaming, welding, melting or applied glue to be assembled. Assembly can happen prior to installation of the fluid flow control assembly 54 within the housing 22.

Remaining components of the fluid flow control assembly 54 will be now described by referencing a unitary valve seat 60 described above. However, such descriptions are equally applicable to the two-piece valve seats 260/360/460 described above.

The biasing member 64 of the relief valve seat assembly 56 is configured to bias the fluid flow control assembly 54 in a position that prevents flow of fluid through the bypass path B and into the flow aperture 100 of the valve seat 60, thereby preventing fluid from by-passing the filter element 28 under normal operating conditions. Specifically, the biasing member 64 is naturally biased to engage with or place a downward pressure D on a top surface 91 of the horizontal segment 90 of the check valve 58 to seal the check valve 58 over the check valve sealing ring 78 and gap G1. As described further in detail below, the end cap 50 of the filter element 28 is also configured to abut against the top surface 91 of the horizontal segment 90 of the check valve 58 over the cartridge sealing ring 76. Accordingly, the gap G1 that extends between the check valve sealing ring 78 and the cartridge sealing ring 76 is sealed by the check valve 58, preventing flow of fluid through the gap G1 under normal conditions. Accordingly, pressure from fluid flowing in the passage P under normal operations may not overcome the downward pressure D of the biasing member 64. However, if the pressure of fluid flowing into the passage P of the valve seat 60 exceeds a certain amount, the pressure of the fluid will overcome the downward pressure D of the biasing member 64, forcing the check valve 58 above the check valve sealing ring 78 to move upward and causing the biasing member 64 to be compressed upward against the stop surface 43 of the tangs 44, as illustrated in FIGS. 6A-6B.

The annular washer 68 of the relief valve seat assembly 56 is configured to be annular in nature and includes a bottom wall 57 and two spaced apart side walls 55 and 53. The bottom wall 57 and spaced apart side walls 55 and 53 form a receiving aperture 69 in the annular washer 68 that can receive a portion of the biasing member 64 as illustrated in FIGS. 4A-6B to retain the biasing member 64 in a fixed position. In particular, the annular washer 68 may retain the biasing member 64 in a position that is longitudinally above the check valve 58, and the annular washer 68 and biasing member 64 may be aligned above the check valve sealing ring 78 of the valve seat 60 to apply the downward force D on a portion of the check valve 58 that abuts against or contacts the check valve sealing ring 78 to maintain the check valve 58 in a sealed position above the gap G1, as illustrated.

In various embodiments, the biasing member 64 may be a spring or other similar biasing mechanism that is retained within the retainment gap 47 of the valve seat 60, although other forms of applying a downward pressure onto the top surface 91 of the horizontal segment 90 of the check valve 58 are envisioned herein. In various embodiments, a top surface 63 of the biasing member 64 engages with the stop surface 43 of one or more tangs 44 of the centering portion 72 of the valve seat 60. Accordingly, the stop surface 43 provides stabilization to the biasing member 64 to be retained within the retainment gap 47 and to permit the biasing member 64 to apply the downward pressure D onto the check valve 58. In various embodiments, a bottom surface 65 of the biasing member 64 abuts against or contacts the top surface 91 of the check valve 58 to apply the downward pressure D. In other embodiments, as illustrated in FIGS. 1-8, a portion of the biasing member 64 may be retained by the annular washer 68, and force from the biasing member 64 is transferred onto the top surface 79 of the check valve 58 via the annular washer 68. Other embodiments of transferring the downward pressure D to the check valve 58 are envisioned herein.

In various embodiments the bottom surface 65 of the biasing member 64 and/or the top surface 63 of the biasing member 64 may include a flat or planar segment 67 that is configured to abut against the check valve 58 and/or the annular washer 68. The flat segment 67 along the circumference of the annular biasing member 64 may exist in a single plane such that the biasing member 64 applies the downward force D consistently to substantially the entire circumference of the check valve 58.

In illustrative embodiments, the valve seat 60 may further include one or more alignment ribs 104 that extend below the base plate sealing ring 74. The alignment ribs 104 may be positioned to be equally spaced apart around the circumference of the valve seat 60, although other locations are envisioned herein. The alignment ribs 104 are configured to extend below the plane P2 of the base plate sealing ring 74 and configured to engage with a portion of the base plate 36 to assist with aligning the fluid flow control assembly 54 in a proper position within the filter assembly 20 when the base plate 36 is secured to the rest of the filter assembly 20. For example, in an illustrative embodiment, the base plate 36 may include a double draw design that features one or more draw-down grooves 106 that form an opening 108 to the interior cavity of the filter assembly 20. The alignment ribs 104 may be formed and positioned to extend into the opening 108 of the draw-down grooves 106 of the base plate 36 in order to align the fluid flow control assembly 54 appropriately with regard to the base plate 36, and thereby the rest of the filter assembly 20, when the base plate 36 is secured to the filter assembly 20. In various embodiments, the draw-down grooves 106 may be annually inward of the raised portion 110 of the base plate 36. Accordingly, the alignment ribs 104 may be positioned to be annularly inward of the engagement between the bottom of the valve seat 60 and the base plate 36 when the valve seat 60 abuts against or contacts the top surface 112 of the raised portion 110.

The relief valve seat assembly 56 may be manufactured in any suitable manner. In one embodiment, the valve seat 60, biasing member 64, and washer 68 may be formed separately and then assembled together. In another embodiment, the biasing member 64 and/or the washer 68 may at least partially be inserted into a mold and rubber and/or another suitable material may be injected into the mold to create the valve seat 60. In this manner, when the injected material sets, the biasing member 64 and/or the washer 68 will be at least partially embedded within the valve seat 60. Other forms of manufacturing the relief valve seat assembly 56 are envisioned herein.

The assembly and operation of the filter assembly 20 and the fluid flow control assembly 54 will now be described. The filter element 28 is assembled with the annular filter media 45 on the core 30 and the end caps 50, 52 secured in place. Assembly of the filter element 28 may occur prior to assembly of the filter assembly 20, for example, the filter element 28 may be purchased from a third party. The spring 40 or other biasing means, if used, is first inserted into the open end of the housing 22 until it seats against the closed end 26 of the housing 22. The filter element 28 is positioned in the housing 22 abutting the spring 40. The spring 40 is configured to keep the filter element 28 positioned away from the end 26 of the housing.

The fluid flow control assembly 54 may be assembled via a snap-lock method, wherein one or more of the components of the fluid flow control assembly 54 are snapped together to be retained in the fluid flow control assembly 54. Accordingly, the present disclosure encompasses a fluid flow control assembly 54 that requires no seaming, welding, melting or applied glue to be assembled. Assembly can happen prior to installation of the fluid flow control assembly 54 within the housing 22.

In an illustrative embodiment, the fluid flow control assembly 54 can be assembled by coupling the check valve 58 to the valve seat 60 by, for instance, positioning the annular walls 42 of the valve seat 60 within the center aperture of the check valve 58 and securing the check valve 58 against the check valve sealing ring 78 of the seat portion 70 of the valve seat 60. The annular washer 68 and biasing member 64 may then be inserted over the annular walls 42 to be received within the retainment gap 47 of the valve seat 60 along the outside surface 41 of the annular walls 42. The biasing member 64 may be snap fit against the stop surface 43 of the tangs 44 of the valve seat 60 to place a downward biasing force onto the annular washer 68 and the check valve 58, thereby holding the components of the fluid flow control assembly 54 in place.

Once assembled, the fluid flow control assembly 54 may be placed into the housing 22 after the filter element 28. The annular walls 42 of the valve seat 60 will be received within the flow opening 31 formed in the core 30 to position the fluid flow control assembly 54 in an appropriate position relative to the rest of the components. This automatic positioning of the fluid flow control assembly 54 advantageously provides a simple and easy way to align the components together for assembly. Further, by such positioning, a portion of the top surface 91 of the check valve 58 will abut against the bottom end cap 50 of the filter element 28. This abutment will, among other things, prevent the fluid flow control assembly 54 from being misaligned within the filter assembly 20 or positioned in an undesired place. This alignment will also help seal undesired fluid flow between the fluid flow control assembly 54 and the core 30 of the filter element 28. The base plate 36 is inserted to close the open end of the housing 22, and a lid 38 is inserted over the base plate 36 to secure all of the components together within the housing 22. The configuration of the fluid flow control assembly 54 further provides correct positioning of the base plate 36 relative to the fluid flow control assembly 54 without additional securement between those components. For example, the fluid flow control assembly 54 may be spaced apart from, or lack contact with, the rim 37 of the outlet opening 80. Further, the alignment ribs 104 that extend toward the base plate 36 may provide some automatic positioning of the base plate 36 relative to the fluid flow control assembly 54 and vice versa. An outer rim 29 of the lid 38 is rolled, for example, with the open end of the housing 22 to form a seal (FIG. 3). Optionally, any other suitable seal may be formed between the lid 38 and the housing 22.

The components are assembled together such that the opening 31 formed by the core 30 of the filter element 28 is generally aligned along the longitudinal axis 82 of the filter assembly 20, and the longitudinal axis A of the valve seat 60 is substantially aligned with the longitudinal axis 82. Accordingly, the outflow aperture 100 of the valve seat 60 will be aligned with the outlet opening 80 of the base plate 36, permitting fluid to flow out of the filter assembly 20.

The components are configured to permit ease of assembling, and may be used for a variety of sizes and shapes of a filter assembly 20. In light of the automatic positioning that occurs by the proposed design, the fluid flow control assembly 54 is not required to be directly or tightly secured to the filter element 28 (e.g. to the core 30 or the end cap 50), and is further not required to be tightly secured to the base plate 36. Such a design provides and advantage in that no tight connection (e.g. snap-lock or similar connection) is required between the fluid flow control assembly 54 and any individual component. Instead, the configuration permits the fluid flow control assembly 54 to be maintained in a proper position by its alignment features and by the pressure applied to the fluid flow control assembly 54 from the components of the filter assembly 20, such as the filter element 28 (which is biased downward by the spring 40) and the base plate 36.

Illustratively, positioning of the base plate 36 in the housing 22 partially compresses the spring 40, whereby, when the parts are assembled, a spring force is applied to the top of the filter element 28 urging the filter element 28 toward the fluid flow control assembly 54 and the base plate 36. If the spring 40 is used, the spring force will help to clamp the fluid flow control assembly 54 between the filter element 28 and the base plate 36, and to restrict flow between the filter element 28 and the base plate 36 (and vice versa) to be via the fluid flow control assembly 54. The core 30 may engage the annular walls 42 of the valve seat 60 and the end cap 50 may also engage and bear upon the generally horizontal segment 90 of the check valve 58, sealing it against the cartridge sealing ring 76 and the check valve sealing ring 78 of the valve seat 60.

In operation, the filter assembly 20 is spun onto a stud on the engine block (not shown), which engages threads (not shown) in the central outlet opening 80 in the base plate 36, and is secured in place. The gasket 25 coupled to the lid 38 will engage the engine block and preclude fluid flow between the engine block and the filter assembly 20. While a particular gasket and lid are described and illustrated, any suitable gasket and lid configurations may be utilized with the principles of the present application.

When the engine is started, fluid, usually oil, will enter the filter assembly 20 through the inlet openings 66. Under normal operations, slight pressure from the entering oil will be applied to the check valve 58, for example, on the bottom side of the angled segment 92. As illustrated in FIGS. 5A-5B, this slight pressure will cause the angled segment 92 to bend upward at the bend 94 in the check valve 58, causing the free end 96 of the angled segment 92 to move away from engagement with the top surface 62 of the base plate 36. Oil will thereafter flow under a normal flow path N past the check valve 58. For example, oil will flow through the inlet openings 66, around the free end 96 of the check valve 58 and the end cap 50 of the filter element 28, through the first face 46 of the filter media of the filter element 28, through the second face 48 of the filter element 28 and past the core 30 of the filter element, into the opening 31, through the flow aperture 100 of the valve seat 60, and then to the outlet opening 80 of the base plate 36 to be discharged for return to the engine. When the engine is turned off, the pressure will decrease, causing the angled segment 92 of the check valve 58 to close against the base plate 36 again, closing access by the inlet openings 66 and preventing return of oil in the filter assembly 20 to the engine.

As the filter media clogs during normal operation, oil will flow into the passage P of the seat portion 70 of the valve seat 60 and hit against the horizontal segment 90 of the check valve 58 the extends across the gap G1. A differential pressure will build across the horizontal segment 90 of the check valve 58, applying an upward force onto the horizontal segment 90. Upon attainment of a predetermined pressure, for example, on the order of between about 6 and about 36 psid at 0.1 gpm with 18 cSt oil in an illustrative embodiment (although other predetermined pressures are envisioned herein), the horizontal segment 90 of the check valve above the check valve sealing ring 78 will overcome the downward pressure D of the biasing member 64 of the valve seat 60, causing the end point 71 of the horizontal segment 90 of the check valve 58 to move upward and to open flow of oil through the gap G1, as illustrated in FIGS. 6A-6B. At this point, oil will flow through the bypass flow path B. For example, oil may flow into the openings 66, through the passage P and the gap G1, into the bypass apertures 102 of the centering portion 72 of the valve seat 60, into the outflow aperture 100 of the valve seat 60, and into the outlet opening 80 of the base plate 36 to exit the filter assembly 20 back to the engine, thereby bypassing the filter media of the filter element 28. In other words, during periods of time when high differential pressure exists across the filter media, due to cold thick oil or high contaminant loading of the filter media, for example, the oil will travel through the passage P and open the horizontal segment 90 of the check valve 58 across the gap G1 of the valve seat 60 to permit oil to bypass the filter media via the bypass path B and exit the filter assembly 20 through the central outlet opening 80 for return to the engine.

In various embodiments, a portion of the horizontal segment 90 of the check valve 58 spaced away from the end point 71 is retained in a fixed position relative to the end point 71 during the by-pass operation, causing the end point 71 of the horizontal segment 90 to pivot upward when the pressure increases past a predetermined threshold. As illustrated, for instance, in FIGS. 4A-6B, the end cap 50 of the filter element 28 may abut against the horizontal segment 90 of the check valve 58 that is aligned over the cartridge sealing ring 76. Force from the spring 40 of the filter assembly 20, as well as compression force from the base plate 36 and lid 38, may retain the end cap against the horizontal segment 90 at this point, creating a pivot area for the rest of the horizontal segment 90 to move in relation to when the oil pressure has exceed the threshold to cause the upward force of the horizontal segment 90 to overcome the downward force D of the biasing member 64. In such a manner, oil is prevented from re-entering a flow path toward the filter element 28 and is directed to passing through the valve seat 60 under the bypass process.

During operation, the biasing member 64 provides the desired amount of predetermined resistance to moving the horizontal segment 90 of the check valve 58 upward to permit passage of oil through the gap G1 at the end of the path P. More particularly, the biasing member 64 is designed with a particular resistance value (based on, for instance, a spring rate, tensile strength, hardness, modulus of elasticity, thickness, number of arms, distance between arms, and other spring properties), wherein the resistance value is overcome upon attainment of the predetermined pressure in the housing (for example, between about 6 and about 36 psid at 0.1 gpm with 18 cSt oil). The predetermined pressure, and thus the necessary resistance valve of the biasing member 64 may be different for different filter assemblies and/or applications. The biasing member 64 is easily customizable for these different applications and provides a more precise resistance value, thereby providing more control over the flow of fluid through path P and through the gap G1 into the bypass apertures 102.

In any of the embodiments herein, a resistance or load on the biasing member 64 when assembled in the filter assembly 20 may be determined by multiplying a surface area of the horizontal segment 90 of the check valve 58 that is exposed to a differential pressure across it, times a predetermined relief valve opening pressure. For example, if an area under the horizontal segment 90 over the gap G1 is approximately 1 square inch and a predetermined valve opening pressure is 20 pounds per square inch (psi), the spring load of the biasing member 64 could be 20 pounds.

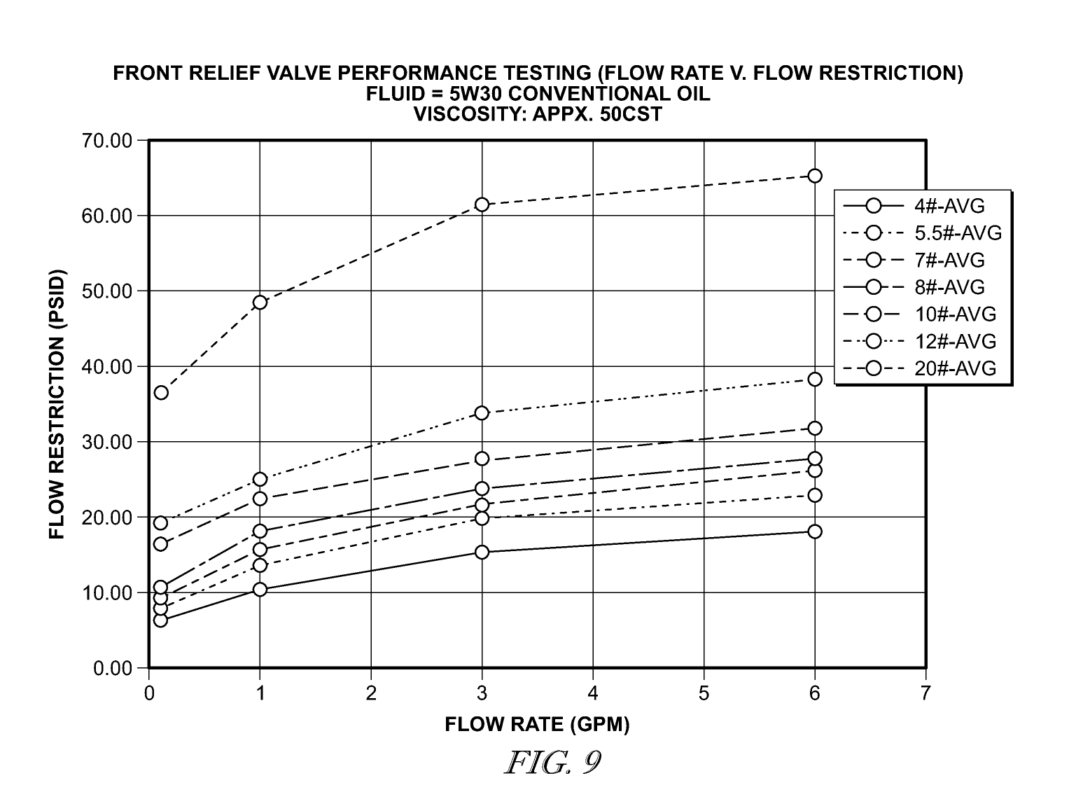

FIG. 9 illustrates exemplary flow curves of flow rate to flow restriction in exemplary embodiment of the fluid flow control assembly 54 having different spring loads. In particular, FIG. 9 illustrates the change in flow restriction across different flow rates for different spring loads (lb-F) when using standard conventional oil (5w30) having a set viscosity (50+/−5 cST (mm2/s)). As illustrated, the flow restriction (PSID, pounds per square inch differential) of the fluid flow control assembly may be increased or decreased at the same flow rates noted (i.e. the curve moves up or down the flow restriction axis) by selecting a spring with different lb-F load at its load height. The higher the average spring load, the higher the flow restriction will be at a given flow rate. Other means of altering the flow curve are envisioned herein.

While directional terminology, such as upper, lower, top, bottom, etc. is used throughout the present application, such terminology is not intended to limit the disclosure. Such terminology is only used for purposes of describing the various features and components in relation to one another. While certain illustrative embodiments have been described in detail in the figures and the foregoing description, such an illustration and description is to be considered as exemplary and not restrictive in character, it being understood that only illustrative embodiments have been shown and described and that all changes and modifications that come within the spirit of the disclosure are desired to be protected. There are a plurality of advantages of the present disclosure arising from the various features of the apparatus, systems, and methods described herein. It will be noted that alternative embodiments of the apparatus, systems, and methods of the present disclosure may not include all of the features described yet still benefit from at least some of the advantages of such features. Those of ordinary skill in the art may readily devise their own implementations of the apparatus, systems, and methods that incorporate one or more of the features of the present disclosure.

We claim:

1. A fluid flow control assembly for a fluid filter, the fluid flow control assembly comprising:
an annular check valve extending between an inner perimeter edge and a spaced apart outer perimeter edge, the annular check valve including a substantially horizontal portion adjacent the inner perimeter edge and an angled portion adjacent the outer perimeter edge, the inner perimeter edge defining an aperture through the check valve; and
a relief valve assembly received within the aperture of the check valve and aligned with the check valve along a longitudinal axis of the fluid filter, the relief valve assembly including a valve seat, a biasing member, and an annular washer, and wherein the valve seat includes a sealing portion formed to include a bypass flow path therethrough and a centering portion including one or more annular walls defining a central opening of the relief valve extending along the longitudinal axis, the sealing portion including a sealing ring that a portion of the horizontal portion of the check valve contacts to prevent flow of fluid from the bypass flow path; and
wherein the biasing member is retained between a stop surface of the one or more annular walls of the valve seat and a top surface of the check valve to bias the check valve toward the sealing portion of the valve seat to block flow of fluid through the bypass flow path.

2. The fluid flow control assembly of claim 1, wherein the biasing member is a helical spring formed in a substantially cylindrical shape.

3. The fluid flow control assembly of claim 2, wherein the annular washer is positioned between the helical spring and the top surface of the check valve that retains a portion of the helical spring.

4. The fluid flow control assembly of claim 3, wherein the helical spring includes a flat surface configured to contact the annular washer.

5. The fluid flow control assembly of claim 1, wherein the valve seat is a two-piece component.

6. The fluid flow control assembly of claim 5, wherein the valve seat includes a centering portion and a seating portion that is separable from the centering portion.

7. The fluid flow control assembly of claim 6, wherein the sealing ring of the sealing portion is integrally formed with the centering portion.

8. The fluid flow control assembly of claim 7, wherein the seating portion includes a cartridge seating portion that is formed separate from the sealing ring of the sealing portion but is aligned radially outward to and substantially parallel with the sealing ring of the sealing portion when the seating portion is coupled together with the centering portion.

9. The fluid flow control assembly of claim 1, wherein the one or more annular walls are spaced apart from one another to define one or more bypass apertures therebetween.

10. The fluid flow control assembly of claim 9, wherein the one or more bypass apertures permit flow of fluid into the central opening of the relief valve assembly.

11. The fluid flow control assembly of claim 9, wherein the one or more bypass apertures are each configured to longitudinally align with the bypass flow path of the sealing portion.

12. The fluid flow control assembly of claim 1, wherein the angled portion of the check valve is configured to move from a blocking position, wherein the angled portion engages with a portion of the oil filter to prevent flow of fluid through a filter element of the oil filter, to a flow position, wherein the angled portion is spaced away from the portion of the oil filter to permit flow of fluid into the filter element.

13. A filter assembly comprising:
a housing open at one end and holding a filter element therein, the housing positioned along a longitudinal axis of the filter assembly;
an base plate secured to the housing at the open end and enclosing the filter element within the housing, the base plate including one or more inlet openings to permit fluid to flow into the housing and an outlet opening to permit fluid to flow out of the housing; and
a fluid flow controller disposed between an end of the filter element and the base plate, the fluid flow controller comprising:
an annular check valve having an inner perimeter edge defining an aperture through the check valve;
a valve seat having a sealing surface substantially perpendicular to the longitudinal axis of the filter assembly and a stop surface substantially perpendicular to the longitudinal axis of the filter assembly, the valve seat configured with a bypass flow passage through the sealing surface, and wherein the check valve is configured to engage with the sealing surface in a sealed position to block flow of fluid through the bypass flow passage;
a biasing member extending parallel to the longitudinal axis between the stop surface and the sealing surface of the valve seat, a bottom of the biasing member applying a biasing force on the check valve adjacent the sealing surface to retain the check valve in the sealed position; and
a washer positioned between the biasing member and the check valve;
wherein the valve seat is received through the aperture of the check valve.

14. The filter assembly of claim 13, wherein the base plate is formed to define a shoulder portion that extends into the housing.

15. The filter assembly of claim 14, wherein the fluid flow controller includes a bottom surface, wherein a portion of the bottom surface contacts the shoulder portion of the base plate.

16. The filter assembly of claim 14, wherein the fluid flow controller is held within the filter assembly by compression between the filter element and the base plate.

17. The filter assembly of claim 13, wherein the inlet openings extend through the shoulder portion.

18. The filter assembly of claim 13, wherein the fluid flow controller includes a central flow opening aligned with the outlet opening of the base plate.

19. The filter assembly of claim 18, wherein the base plate includes a rim that defines the outlet opening, and wherein the fluid flow controller does not contact the rim.

20. The filter assembly of claim 13, wherein the fluid flow controller includes a bottom surface having one or more alignment ribs that extend below the bottom surface.

21. The filter assembly of claim 20, wherein each of the one or more alignment ribs is annularly spaced around the fluid flow controller.

22. The filter assembly of claim 20, wherein each of the one or more alignment ribs is received within a groove formed in the base plate.

23. A valve seat for a relief valve assembly, the valve seat extending along a longitudinal axis and comprising:
a sealing portion formed to include a bypass flow path therethrough, the sealing portion including an inner sealing ring and an outer sealing ring that is radially outward of the inner sealing ring, the inner and outer sealing rings extending in a first plane and defining a gap therebetween, the gap forming an outlet for the bypass flow path, the inner and outer sealing rings each including a top surface that a check valve of the relief valve assembly engages when the check valve blocks the gap; and
a centering portion positioned adjacent to the inner sealing ring, the centering portion including two or more annular walls defining a central opening of the valve seat along the longitudinal axis, the annular walls spaced apart from each other to provide a bypass aperture that is in fluid communication with the gap of the sealing portion and the central opening to permit fluid flowing through the bypass flow path of the sealing portion to flow to the central opening.

24. The valve seat of claim 23, wherein the inner sealing ring is formed with the centering portion.

25. The valve seat of claim 23, wherein the annular walls of the centering portion further include one or more tangs that protrude radially outward of the annular walls, and wherein the tangs provide a stop surface to retain a biasing member of the relief valve assembly.

26. The valve seat claim 23, wherein the bypass aperture of the centering portion extends from the inner sealing ring to a top of the centering portion.

27. The valve seat of claim 23, wherein the bypass aperture of the centering portion extends into a bypass aperture formed in the inner sealing ring of the sealing portion.

28. The valve seat of claim 23, wherein the bypass aperture is radially offset from the gap between the sealing rings.

29. The valve seat of claim 23, wherein the sealing portion further comprises a third sealing ring that extends in a second plane spaced apart from the first plane, the third sealing ring being substantially parallel with the inner and outer sealing rings and further forming a portion of the bypass flow path.

30. The valve seat of claim 29, wherein the third sealing ring is coupled to the inner sealing ring via a connection wall that is perpendicular to the third sealing ring and the inner sealing ring.

31. The valve seat of claim 29, wherein the third sealing ring further includes one or more alignment ribs that extend in a direction away from the inner and outer sealing rings.

32. The valve seat of claim 23, wherein the inner and outer sealing rings are formed to be separated from each other.

33. The valve seat of claim 23, wherein the inner and outer sealing rings are connected together via one or more connection bridges that extend across the gap, the connection bridges extending in the first plane.
